(19) United States
(12) Patent Application Publication
(10) Pub. No.: US 2024/0284168 A1
(43) Pub. Date: Aug. 22, 2024

(54) PHYSICAL LAYER SECURITY IN WIRELESS COMMUNICATIONS

(71) Applicant: QUALCOMM Incorporated, San Diego, CA (US)

(72) Inventors: Ahmed ELSHAFIE, San Diego, CA (US); Alexandros MANOLAKOS, Athens, CA (US)

(21) Appl. No.: 18/292,238

(22) PCT Filed: Aug. 31, 2022
(86) PCT No.: PCT/US2022/042130

§ 371 Date: Jan. 25, 2024

(30) Foreign Application Priority Data
Oct. 1, 2021 (GR) 20210100659

(51) Int. Cl. H04W 12/041

(52) U.S. Cl. CPC H04W 12/041

(57) ABSTRACT

Methods, systems, and devices for wireless communications are described. A user equipment (UE) may be configured with a security key generation procedure configuration using control messaging. In accordance with the security key generation procedure, the UE may transmit a sounding reference signal to the base station using one or more first antennas of a plurality of antennas configured at the UE. The UE may receive, from the base station, a downlink reference signal using the one or more first antennas and determine one or more eigenvalues or eigenvectors based on a channel estimation associated with the downlink reference signal. The UE may use the one or more eigenvalues or eigenvectors to derive a security key that is used to secure communications between the base station and the UE.

### CROSS REFERENCE

The present Application is a 371 national stage filing of International PCT Application No. PCT/US2022/042130 by ELSHAFIE et al. entitled “PHYSICAL LAYER SECURITY IN WIRELESS COMMUNICATIONS,” filed Aug. 31, 2022; and claims priority to Greece Patent Application No. 20210100659 by ELSHAFIE et al., entitled “PHYSICAL LAYER SECURITY IN WIRELESS COMMUNICATIONS,” filed Oct. 1, 2021, each of which is assigned to the assignee hereof, and each of which is expressly incorporated by reference in its entirety herein.

### FIELD OF TECHNOLOGY

The following relates to wireless communications, including physical layer security in wireless communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

Some wireless communications systems may implement security schemes to secure or encrypt communications between devices, such as communications between a base station and a UE. In some examples, the devices may use a security key to secure such communications. These techniques may be used to reduce or limit the ability for other devices, such as other UEs, to eavesdrop on communications and identify data intended to be secure.

### SUMMARY

The described techniques relate to improved methods, systems, devices, and apparatuses that support physical layer security in wireless communications. Generally, the described techniques provide for a user equipment (UE) being configured with a security key generation procedure configuration using control messaging. The security key generation procedure may be used for generation of a security key that is used for securing communications between a base station and the UE. In accordance with the security key generation procedure, the UE may transmit a sounding reference signal to the base station using one or more first antennas of a plurality of antennas configured at the UE. The base station may determine one or more eigenvalues or eigenvectors based on the sounding reference signal. The UE may receive, from the base station, a downlink reference signal using the one or more first antennas and determine one or more eigenvalues or eigenvectors based on a channel estimation associated with the downlink reference signal. The UE may use the one or more eigenvalues or eigenvectors to derive a security key that is used to secure communications between the base station and the UE. Assuming channel reciprocity for uplink and downlink channels between the base station and the UE, the base station and the UE should identify the same or similar eigenvalues or eigenvectors and derive the same security key. Some techniques described herein support confirming that the derived security key is the same for the base station and the UE.

A method for wireless communications at a user equipment (UE) is described. The method may include receiving, from a base station, a control message indicating a configuration for a security key generation procedure for communications between the UE and the base station, transmitting, to the base station, a sounding reference signal using one or more first antennas of a set of multiple antennas in accordance with the configuration, receiving, from the base station, a downlink reference signal using the one or more first antennas in accordance with the configuration, determining one or more eigenvalues or eigenvectors based on a channel estimation of a channel associated with the downlink reference signal, and communicating, with the base station, via the communications secured using a security key derived using the one or more eigenvalues or eigenvectors.

An apparatus for wireless communications at a UE is described. The apparatus may include a processor, memory coupled with the processor, and instructions stored in the memory. The instructions may be executable by the processor to cause the apparatus to receive, from a base station, a control message indicating a configuration for a security key generation procedure for communications between the UE and the base station, transmit, to the base station, a sounding reference signal using one or more first antennas of a set of multiple antennas in accordance with the configuration, receive, from the base station, a downlink reference signal using the one or more first antennas in accordance with the configuration, determine one or more eigenvalues or eigenvectors based on a channel estimation of a channel associated with the downlink reference signal, and communicate, with the base station, via the communications secured using a security key derived using the one or more eigenvalues or eigenvectors.

Another apparatus for wireless communications at a UE is described. The apparatus may include means for receiving, from a base station, a control message indicating a configuration for a security key generation procedure for communications between the UE and the base station, means for transmitting, to the base station, a sounding reference signal using one or more first antennas of a set of multiple antennas in accordance with the configuration, means for receiving, from the base station, a downlink reference signal using the one or more first antennas in accordance with the configuration, means for determining one or more eigenvalues or eigenvectors based on a channel estimation of a channel associated with the downlink reference signal, and means for communicating, with the base station, via the communications secured using a security key derived using the one or more eigenvalues or eigenvectors.

A non-transitory computer-readable medium storing code for wireless communications at a UE is described. The code may include instructions executable by a processor to receive, from a base station, a control message indicating a configuration for a security key generation procedure for communications between the UE and the base station, transmit, to the base station, a sounding reference signal using one or more first antennas of a set of multiple antennas in accordance with the configuration, receive, from the base station, a downlink reference signal using the one or more first antennas in accordance with the configuration, determine one or more eigenvalues or eigenvectors based on a channel estimation of a channel associated with the downlink reference signal, and communicate, with the base station, via the communications secured using a security key derived using the one or more eigenvalues or eigenvectors.

Some examples of the method, apparatuses, and non-transitory computer-readable medium described herein may further include operations, features, means, or instructions for transmitting, to the base station, an indication of the one or more eigenvalues or eigenvectors and receiving, from the base station, a downlink control information message that indicates a security key derivation status, where the UE communicates with the base station based on the security key derivation status.

In some examples of the method, apparatuses, and non-transitory computer-readable medium described herein, transmitting the indication of the one or more eigenvalues or eigenvectors may include operations, features, means, or instructions for transmitting a hash value of the one or more eigenvalues or eigenvectors.

In some examples of the method, apparatuses, and non-transitory computer-readable medium described herein, communicating with the base station may include operations, features, means, or instructions for transmitting, to the base station, an uplink control information message that may be encoded using the security key.

In some examples of the method, apparatuses, and non-transitory computer-readable medium described herein, transmitting the uplink control information message may include operations, features, means, or instructions for transmitting the uplink control information message that includes an acknowledgement corresponding to the downlink reference signal.

Some examples of the method, apparatuses, and non-transitory computer-readable medium described herein may further include operations, features, means, or instructions for receiving, from the base station, a downlink control information message that indicates a security key derivation status, where the UE communicates with the base station based on the security key derivation status.

In some examples of the method, apparatuses, and non-transitory computer-readable medium described herein, receiving the downlink control information message may include operations, features, means, or instructions for receiving the downlink control information message that may be encoded using the security key derived at the base station and decoding the downlink control information message using the security key derived by the UE.

Some examples of the method, apparatuses, and non-transitory computer-readable medium described herein may further include operations, features, means, or instructions for receiving, via the downlink reference signal, an indication of base station computed one or more eigenvalues or eigenvectors, comparing, the one or more eigenvalues or eigenvectors computed by the UE to the base station computed one or more eigenvalues or eigenvectors, and deriving the security key using the one or more eigenvalues or eigenvectors based on a result of the comparing.

Some examples of the method, apparatuses, and non-transitory computer-readable medium described herein may further include operations, features, means, or instructions for deriving the security key using a quantized value of the one or more eigenvalues or eigenvectors in accordance with the configuration.

Some examples of the method, apparatuses, and non-transitory computer-readable medium described herein may further include operations, features, means, or instructions for deriving the security key using the one or more eigenvalues or eigenvectors using a hash function, a security key derivation function, or a combination thereof, in accordance with the configuration.

In some examples of the method, apparatuses, and non-transitory computer-readable medium described herein, receiving the control message may include operations, features, means, or instructions for receiving an indication of one or more quantization levels used to determine a value for the one or more eigenvalues or eigenvectors, where the value may be used to derive the security key.

Some examples of the method, apparatuses, and non-transitory computer-readable medium described herein may further include operations, features, means, or instructions for deriving the security key using a key derivation function in accordance with the configuration, where the UE communicates with the base station using a physical downlink shared channel transmission, a physical uplink shared channel transmission, a medium access control layer control element message, a physical uplink control channel transmission, or a combination thereof that may be secured using the security key.

In some examples of the method, apparatuses, and non-transitory computer-readable medium described herein, determining the one or more eigenvalues or eigenvectors may include operations, features, means, or instructions for determining the one or more eigenvalues or eigenvectors using one or more resources in accordance with the configuration.

In some examples of the method, apparatuses, and non-transitory computer-readable medium described herein, the one or more resources may be contiguous or non-contiguous resource elements, contiguous or non-contiguous resource blocks, contiguous or non-contiguous physical resource block groups, a wideband frequency band, or a combination thereof.

In some examples of the method, apparatuses, and non-transitory computer-readable medium described herein, receiving the control message may include operations, features, means, or instructions for receiving the control message that configures an uplink resource for transmitting the sounding reference signal and a downlink resource for receiving the downlink reference signal, where the uplink resource may be quasi-co located with the downlink resource.

In some examples of the method, apparatuses, and non-transitory computer-readable medium described herein, receiving the control message may include operations, features, means, or instructions for receiving the control message that configures a bandwidth part for transmitting the sounding reference signal and receiving the downlink reference signal, where the sounding reference signal may be transmitted and the downlink reference signal may be received on the bandwidth part in accordance with the configuration.

In some examples of the method, apparatuses, and non-transitory computer-readable medium described herein, communicating with the base station may include operations, features, means, or instructions for encoding one or more fields in a physical uplink control channel transmission, a physical uplink shared channel transmission, or both, using the security key.

In some examples of the method, apparatuses, and non-transitory computer-readable medium described herein, communicating with the base station may include operations, features, means, or instructions for decoding one or more fields in a downlink control information message using the security key.

In some examples of the method, apparatuses, and non-transitory computer-readable medium described herein, the one or more fields include a redundancy value index, a modulation and coding scheme index, a time domain resource assignment index, a frequency domain resource assignment index, or a combination thereof.

Some examples of the method, apparatuses, and non-transitory computer-readable medium described herein may further include operations, features, means, or instructions for determining, based on a value of the security key, a subset of search spaces of a set of multiple search spaces configured at the UE or one or more blind search parameters and performing blind decoding in the subset of search spaces, using the one or more blind search parameters, or both.

Some examples of the method, apparatuses, and non-transitory computer-readable medium described herein may further include operations, features, means, or instructions for determining that the one or more eigenvalues or eigenvectors determined at the UE may be different from base station computed one or more eigenvalues or eigenvectors and retransmitting the one or more sounding reference signal based on the determining.

In some examples of the method, apparatuses, and non-transitory computer-readable medium described herein, receiving the downlink reference signal may include operations, features, means, or instructions for receiving a channel state information reference signal.

A method for wireless communications at a base station is described. The method may include transmitting, to a UE, a control message indicating a configuration for a security key generation procedure for communications between the UE and the base station, receiving, from the UE, a sounding reference signal in accordance with the configuration, determining one or more one or more eigenvalues or eigenvectors based on a channel estimation of a channel associated with the sounding reference signal, transmitting, to the UE, a downlink reference signal in accordance with the configuration, and communicating, with the UE, via the communications secured using a security key derived using the one or more eigenvalues or eigenvectors.

An apparatus for wireless communications at a base station is described. The apparatus may include a processor, memory coupled with the processor, and instructions stored in the memory. The instructions may be executable by the processor to cause the apparatus to transmit, to a UE, a control message indicating a configuration for a security key generation procedure for communications between the UE and the base station, receive, from the UE, a sounding reference signal in accordance with the configuration, determine one or more one or more eigenvalues or eigenvectors based on a channel estimation of a channel associated with the sounding reference signal, transmit, to the UE, a downlink reference signal in accordance with the configuration, and communicate, with the UE, via the communications secured using a security key derived using the one or more eigenvalues or eigenvectors.

Another apparatus for wireless communications at a base station is described. The apparatus may include means for transmitting, to a UE, a control message indicating a configuration for a security key generation procedure for communications between the UE and the base station, means for receiving, from the UE, a sounding reference signal in accordance with the configuration, means for determining one or more one or more eigenvalues or eigenvectors based on a channel estimation of a channel associated with the sounding reference signal, means for transmitting, to the UE, a downlink reference signal in accordance with the configuration, and means for communicating, with the UE, via the communications secured using a security key derived using the one or more eigenvalues or eigenvectors.

A non-transitory computer-readable medium storing code for wireless communications at a base station is described. The code may include instructions executable by a processor to transmit, to a UE, a control message indicating a configuration for a security key generation procedure for communications between the UE and the base station, receive, from the UE, a sounding reference signal in accordance with the configuration, determine one or more one or more eigenvalues or eigenvectors based on a channel estimation of a channel associated with the sounding reference signal, transmit, to the UE, a downlink reference signal in accordance with the configuration, and communicate, with the UE, via the communications secured using a security key derived using the one or more eigenvalues or eigenvectors.

Some examples of the method, apparatuses, and non-transitory computer-readable medium described herein may further include operations, features, means, or instructions for receiving, from the UE, an indication of UE computed one or more eigenvalues or eigenvectors, comparing, the one or more eigenvalues or eigenvectors computed by the base station to the UE computed one or more eigenvalues or eigenvectors, and transmitting, to the UE, a downlink control information message at indicates a security key derivation status resulting from the comparing, where the UE communicates with the base station based on the security key derivation status.

In some examples of the method, apparatuses, and non-transitory computer-readable medium described herein, receiving the indication of the UE computed one or more eigenvalues or eigenvectors may include operations, features, means, or instructions for receiving a hash value of the UE computed one or more eigenvalues or eigenvectors, where the base station compares the hash value of the UE computed one or more eigenvalues or eigenvectors to a hash value of the one or more eigenvalues or eigenvectors computed by the base station.

In some examples of the method, apparatuses, and non-transitory computer-readable medium described herein, transmitting the downlink control information message may include operations, features, means, or instructions for transmitting the downlink control information message that may be encoded with the security key to indicate the security key derivation status.

Some examples of the method, apparatuses, and non-transitory computer-readable medium described herein may further include operations, features, means, or instructions for receiving, from the UE, an uplink control information message that may be encoded using the security key derived at the UE and decoding the uplink control information message using the security key.

In some examples of the method, apparatuses, and non-transitory computer-readable medium described herein, the uplink control information message includes an acknowledgement corresponding to the downlink reference signal.

Some examples of the method, apparatuses, and non-transitory computer-readable medium described herein may further include operations, features, means, or instructions for transmitting, to the base station, an indication of the one or more eigenvalues or eigenvectors computed by the base station.

In some examples of the method, apparatuses, and non-transitory computer-readable medium described herein, transmitting the indication of the one or more eigenvalues or eigenvectors may include operations, features, means, or instructions for transmitting a hash value of the one or more eigenvalues or eigenvectors.

Some examples of the method, apparatuses, and non-transitory computer-readable medium described herein may further include operations, features, means, or instructions for deriving the security key using a quantized value of the one or more eigenvalues or eigenvectors in accordance with the configuration.

Some examples of the method, apparatuses, and non-transitory computer-readable medium described herein may further include operations, features, means, or instructions for deriving the security key using the one or more eigenvalues or eigenvectors using a hash function, a security key derivation function, or a combination thereof, in accordance with the configuration.

Some examples of the method, apparatuses, and non-transitory computer-readable medium described herein may further include operations, features, means, or instructions for transmitting, to the UE, an indication of one or more quantization levels used to determine a value using the one or more eigenvalues or eigenvectors, where the value may be used to derive the security key.

Some examples of the method, apparatuses, and non-transitory computer-readable medium described herein may further include operations, features, means, or instructions for deriving the security key using a key derivation function in accordance with the configuration, where the base station communicates with the UE using a physical downlink shared channel transmission, a physical uplink shared channel transmission, a medium access control layer control element message, a physical uplink control channel transmission, or a combination thereof that may be secured using the security key.

In some examples of the method, apparatuses, and non-transitory computer-readable medium described herein, determining the one or more eigenvalues or eigenvectors may include operations, features, means, or instructions for determining the one or more eigenvalues or eigenvectors using one or more resources in accordance with the configuration.

In some examples of the method, apparatuses, and non-transitory computer-readable medium described herein, the one or more resources may be contiguous or non-contiguous resource elements, contiguous or non-contiguous resource blocks, contiguous or non-contiguous physical resource block groups, a wideband frequency band, or a combination thereof.

In some examples of the method, apparatuses, and non-transitory computer-readable medium described herein, transmitting the control message may include operations, features, means, or instructions for transmitting the control message that configures an uplink resource for receiving the sounding reference signal and a downlink resource for transmitting the downlink reference signal, where the uplink resource may be quasi-co located with the downlink resource.

In some examples of the method, apparatuses, and non-transitory computer-readable medium described herein, transmitting the control message may include operations, features, means, or instructions for transmitting the control message that configures a bandwidth part for receiving the sounding reference signal and transmitting the downlink reference signal, where the sounding reference signal may be received and the downlink reference signal may be transmitted on the bandwidth part in accordance with the configuration.

In some examples of the method, apparatuses, and non-transitory computer-readable medium described herein, communicating with the UE may include operations, features, means, or instructions for decoding one or more fields a physical uplink control channel transmission, a physical uplink shared channel transmission, or both, using the security key.

In some examples of the method, apparatuses, and non-transitory computer-readable medium described herein, communicating with the base station may include operations, features, means, or instructions for encoding one or more fields in a downlink control information message using the security key.

In some examples of the method, apparatuses, and non-transitory computer-readable medium described herein, the one or more fields include a redundancy value index, a modulation and coding scheme index, a time domain resource assignment index, a frequency domain resource assignment index, or a combination thereof.

Some examples of the method, apparatuses, and non-transitory computer-readable medium described herein may further include operations, features, means, or instructions for determining, based on a value of the security key, a subset of search spaces of a set of multiple search spaces configured at the UE or one or more blind search parameters and transmitting a downlink control information message in the subset of search spaces, in accordance with the one or more blind search parameters, or both.

Some examples of the method, apparatuses, and non-transitory computer-readable medium described herein may further include operations, features, means, or instructions for determining that the one or more eigenvalues or eigenvectors determined at the base station may be different from UE computed one or more eigenvalues or eigenvectors and receiving a retransmission of the sounding reference signal based on the determining.

In some examples of the method, apparatuses, and non-transitory computer-readable medium described herein, transmitting the downlink reference signal may include operations, features, means, or instructions for transmitting a channel state information reference signal.

### BRIEF DESCRIPTION OF THE DRAWINGS

FIG. 1 illustrates an example of a wireless communications system that supports physical layer security in wireless communications in accordance with aspects of the present disclosure.

FIG. 2 illustrates an example of a wireless communications system that supports physical layer security in wireless communications in accordance with aspects of the present disclosure.

FIG. 3A and FIG. 3B illustrate examples of wireless communications timelines that support physical layer security in wireless communications in accordance with aspects of the present disclosure.

FIG. 4 illustrates an example of a process flow that supports physical layer security in wireless communications in accordance with aspects of the present disclosure.

FIGS. 5 and 6 show block diagrams of devices that support physical layer security in wireless communications in accordance with aspects of the present disclosure.

FIG. 7 shows a block diagram of a communications manager that supports physical layer security in wireless communications in accordance with aspects of the present disclosure.

FIG. 8 shows a diagram of a system including a device that supports physical layer security in wireless communications in accordance with aspects of the present disclosure.

FIGS. 9 and 10 show block diagrams of devices that support physical layer security in wireless communications in accordance with aspects of the present disclosure.

FIG. 11 shows a block diagram of a communications manager that supports physical layer security in wireless communications in accordance with aspects of the present disclosure.

FIG. 12 shows a diagram of a system including a device that supports physical layer security in wireless communications in accordance with aspects of the present disclosure.

FIGS. 13 through 16 show flowcharts illustrating methods that support physical layer security in wireless communications in accordance with aspects of the present disclosure.

### DETAILED DESCRIPTION

Wireless communications systems may support techniques for securing communications. In some cases, secret keys may be used to encrypt or otherwise secure data in transmissions between devices of a wireless communications system. For example, a secret key may be used by a base station and a user equipment (UE) to secure some fields within a physical channel such as information in a physical downlink control channel (PDCCH), a physical uplink control channel (PUCCH), physical downlink shared channel (PDSCH), or a physical uplink shared channel (PUSCH). According to some key extraction procedures, the UE and the base station may exchange reference signals and determine a channel metric based on the respective reference signals. The channel metric may be used as the basis for a seed to a key derivation function to determine a secret key. Because of channel reciprocity between the base station and the UE, each device should determine the same channel metric and thus derive the same secret key.

Techniques described herein support secret key determination at the physical layer using channel reciprocity and channel estimation. A UE may be configured, by a base station, with a security key generation procedure configuration. According to the configuration, the UE may transmit, to the base station, a sounding reference signal (SRS) using one or more of a plurality of antennas configured at the UE. The base station may estimate the channel to identify one or more eigenvalues or eigenvectors. The base station may also transmit a downlink reference signal to the UE, and the UE may receive the downlink reference signal using the one or more antennas that were used to transmit the SRS. The UE may estimate the channel based on the downlink reference signal to identify one or more eigenvalues or eigenvectors. Assuming channel reciprocity for uplink and downlink communications and because the same antennas were used for transmission and reception, the base station and the UE should identify the same one or more eigenvalues or eigenvectors based on the respective channel estimations. These one or more eigenvalues or eigenvectors may be used as the basis for a secret key. Accordingly, the base station and the UE may identify the same (e.g., a symmetric) secret key that may be used for securing communications. In some examples, various procedures may be used to confirm that the same key is derived, such as encoding/decoding downlink control information messages, encoding/encoding uplink control information (UCI) messages, comparing hash values of the eigenvalue or eigenvectors, or a combination thereof.

Aspects of the disclosure are initially described in the context of wireless communications systems. Aspects of the disclosure are further described with respect to a wireless communications system implementing a security key generation procedure and wireless communications timelines illustrating aspects of the security key generation procedure. Aspects of the disclosure are further illustrated by and described with reference to a process flow diagram, apparatus diagrams, system diagrams, and flowcharts that relate to physical layer security in wireless communications.

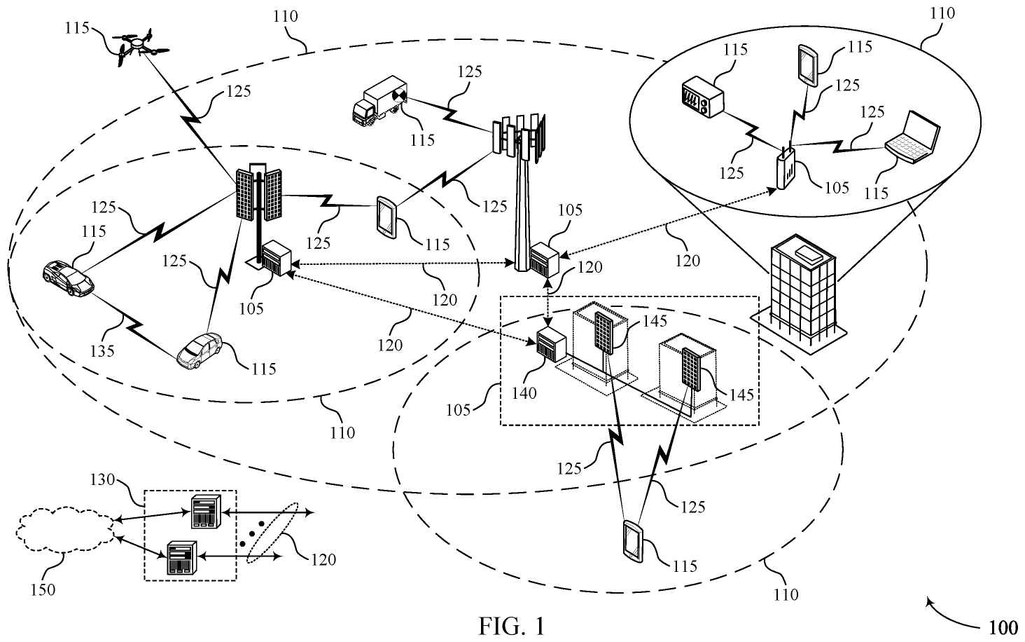

FIG. 1 illustrates an example of a wireless communications system 100 that supports physical layer security in wireless communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (0 f) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the medium access control (MAC) layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support physical layer security schemes between a base station 105 and UEs 115. In some cases, these physical layer security schemes may rely on the position of the UE 115 relative to the base station 105 to derive secret keys that are used to secure communications. As the position of the UE 115 relative to the base station 105 may impact various channel characteristics, the use of channel estimation to determine secret keys may improve security within the wireless communications system 100. This may be due to the various UEs 115 having different channel characteristics due to differences in position relative to a particular base station 105.

According to some secret key extract procedures. two devices, such as a base station 105 and a UE 115, may exchange reference signals. Each device (e.g., the base station 105 and the UE 115) may estimate its channel based on the received reference signal and obtain a metric based on the channel (e.g., channel power, reference signal received power (RSRP), signal interference to noise ratio (SINR), and phase). The obtained metric may be quantized and mapped to a value that is used as a secret key or used to derive a secret key. Thus, due to channel reciprocity, the secret key may be obtained by both devices. At high signal to noise environments, these techniques may be secured, or the repetition of pilot signals or other key refinement procedures may be used. The secret key may be used by the base station 105 and the UE 115 to secure communications, such as by securing fields within a physical channel (e.g., information in a PDCCH, PUCCH, PDSCH, and/or PUSCH).

Techniques described herein support secret key generation that leverages channel reciprocity and channel estimations. A UE 115 may be configured, by a base station 105, with a configuration for a secret key generation procedure. The UE 115 may transmit, to the base station 105, a SRS using one or more antennas according to the configuration. The base station 105 may estimate the channel based on the received SRS to identify one or more eigenvalues or eigenvector that may be used as the basis for secret key. The base station 105 may transmit a downlink reference signal to the UE 115, and the UE 115 may receive the downlink reference signal using the one or more antennas that were used to transmit the sounding reference signal in accordance with the security key generation procedure. The UE 115 may estimate the channel based on the downlink reference signal to identify one or more eigenvalues or eigenvectors that may the basis for a security key. Assuming channel reciprocity for the SRS and the downlink reference signal, the UE 115 and the base station may identify the same or similar eigenvalues or eigenvectors that are used to generate the same key. Thus, the base station 105 and the UE 115 may use the key to secure communications, such as fields in various physical channels.

In some cases, the UE 115 may transmit an indication of UE computed eigenvalues or eigenvectors such that the base station 105 may confirm that the procedure was successful. For example, the UE 115 may compute and transmit a hash value of at least one of the eigenvalues or eigenvectors, and the base station 105 may compare the hash value computed by the UE 115 to a hash value computed by the base station 105. In the same or another example, the base station 105 transmits an indication (e.g., hash value) of an eigenvalue or eigenvector to the UE 115. In the same or another example, DCI and/or UCI is encoded using the hash value of a computed eigenvalue or eigenvector. If a receiving device is able to decode the respective one of the DCI or UCI, then it may be confirmed that the key was identified correctly at both the UE 115 and the base station 105.

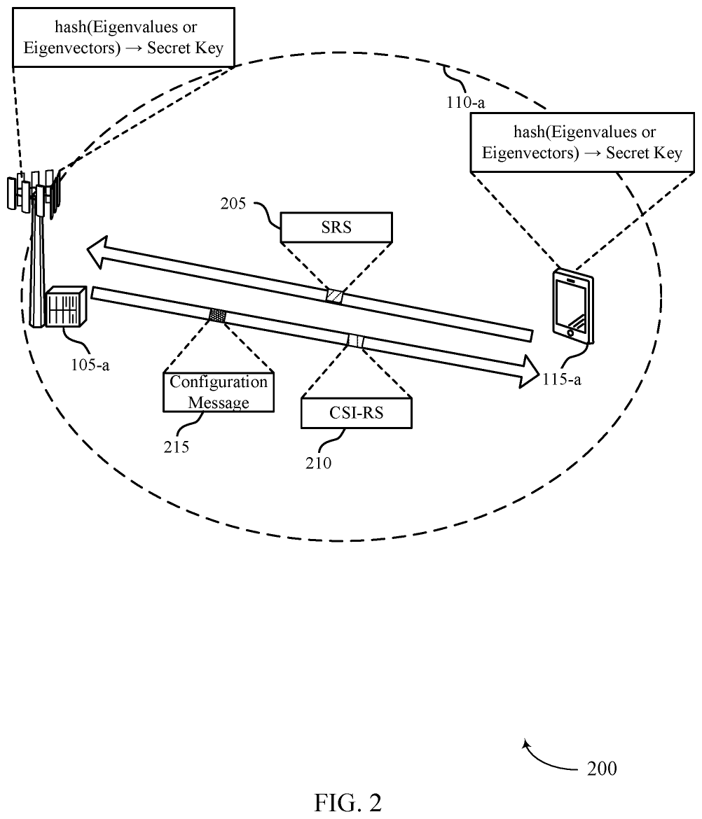

FIG. 2 illustrates an example of a wireless communications system 200 that supports physical layer security in wireless communications in accordance with aspects of the present disclosure. The wireless communications system 200 includes a base station 105-a, a UE 115-a, and a UE 115-b, which may be examples of the corresponding devices of wireless communications system 100 of FIG. 1. Various aspects of techniques described with respect to FIG. 2 may be performed by devices other than base station 105-a and UE 115-a. For example, various aspects of the techniques described herein may be performed by two UEs 115 in a sidelink communication scenario.

Base station 105-a may communicate with UE 115-a that is positioned with a coverage area 110-a of the base station 105-a according to techniques described herein. For example, base station 105-a and UE 115-a may use the techniques described herein to derive a secret key that is used to secure various communications between the UE 115-a and the base station 105-a. In some cases, the derived secret key may be used to secure information communicated using resources of a PDCCH, PDSCH, PUSCH, or a PUCCH. The UE 115-a and the base station 105-a may use higher layer security schemes for securing communications. To further improve security, the physical layer security scheme described herein depends on channel characteristics and is used to secure control channels (e.g., NR control channels), such an uplink control information (UCI) and downlink control information (DCI). Securing the control channels (e.g., UCI and DCI) may make it difficult for the eavesdroppers to perform decoding and disturb activities that may secure the system. Thus, these physical layer security schemes may be used in addition to the upper layer security schemes to further secure the wireless communications system 200.

The base station 105-a may transmit one or more control messages (e.g., configuration message 215) to configure a security key generation procedure as described herein. For example, the base station may configure the security key generation procedure using radio resource control (RRC) or medium access control layer control element (MAC-CE) signaling and activate the security key generation procedure using MAC-CE and/or DCI signaling. In some examples, the base station 105-a may configure the UE 115-a with quasi co-located (QCL) uplink and downlink reference signal resources that are used to extract the keys. The resources (e.g., resource elements (REs) and/or resource blocks (RBs)) may be configured in the same bandwidth part. After configuration and/or activation, the UE 115-a and the base station 105-a may use time domain multiplexed resources, on the same bandwidth part, for security key extraction according to one or more of the procedures described herein. The resources that are used for security key extraction may correspond to the same transmission configuration indication (TCI) state or may be resources that have a QCL relationship. In some examples, the UE 115-a may transmit a response or agreement indication in response to the configuration (e.g., RRC configuration) or activation of the security key generation procedure.

According the techniques described herein, the UE 115-a sends a SRS to the base station 105-a using the SRS resource configured by the configuration message 215. The base station 105-a may estimate the channel of the SRS to extract eigenvalues and/or eigenvectors associated with the SRS resource. For example, the base station 105-a may obtain the singular value decomposition (SVD), which may be an example of an eigen-decomposition, of the channel matrix. The one or more eigenvalues may correspond to REs indicated via the configuration message 215. For example, the base station 105-a may calculate eigenvalues corresponding to two REs.

The base station 105-a may transmit a downlink reference signal 210 to the UE 115-a. The downlink reference signal may be transmitted using one or more antennas that were used to estimate the channel using the SRS 205. Additionally, the downlink reference signal may be received at the UE 115-a using one or more antennas that were used to transmit the SRS 205 according to the configured SRS resources. The downlink reference signal 210 may be an example of a CSI-RS and may be precoded or unprecoded. If the CSI-RS is precoded, it may be precoded using K eigenvectors where K corresponds to the sounded SRS resource at the UE 115-a, which may be RRC configured as described herein.

As the SRS 205 and the downlink reference signal 210 (CSI-RS) correspond to a same channel (e.g., due to the resources corresponding to the same TCI state or being QCL), the UE 115-a and the base station 105-a should calculate the same eigenvalues or eigenvectors. As such, one or more of the eigenvalues or eigenvectors (e.g., corresponding to a configured resources) may be used to generate a secret key for securing communications. For example, the one or more eigenvalues or eigenvectors may be input into a key generation function to generate a key. Additionally or alternatively, the UE 115-a and the base station 105-a may compute hash values of the one or more eigenvalues or eigenvectors. As described in further detail herein, the UE 115-a and the base station 105-a may perform various techniques to ensure that the same eigenvalues or eigenvectors are identified, and hence the same secret key generated.

According to a first technique, the UE 115-a may report an indication of its computed eigenvalues or eigenvectors to the base station 105-a. For example, the UE 115-a may calculate a hash value of the eigenvalues or eigenvectors (e.g., corresponding to configured resources) and transmit the hash value to the base station 105-a. The base station 105-a may compare the hash value received from the UE 115-a to a hash value of the base station computed eigenvalues or eigenvectors (e.g., corresponding to the same resources). If the values are the same, then the procedure was performed successfully, and the base station 105-a and the UE 115-a may communicate using a security key that is based on the eigenvalues or eigenvectors. In the same or an alternative example, the base station 105-a may transmit an indication of the base station 105-a computed eigenvalues or eigenvectors (e.g., hash values) to the UE 115-a. In such cases, the UE 115-a may compare the hash values to confirm whether the key generation procedure was successful.

In some cases, the UE 115-a and/or the base station may encode control messages using the hash values of the respective computed eigenvalues or eigenvectors. For example, the base station 105-a may encode a DCI transmission using the hash value, and if the UE 115-a is able to successfully decode the DCI using the UE 115-a computed hash value (e.g., based on the UE 115-a computed eigenvalues or eigenvectors), then the key generation procedure is successful. Additionally or alternatively, the UE 115-a may encode an UCI transmission with the UE 115-a computed hash value. If the base station 105-a is able to successfully decode the hash value, then the key generation procedure is successful. In some cases, one or both devices may acknowledge the successful procedure. For example, the base station 105-a may send a DCI message to confirm the key agreement procedure.

The derived secret key may be hash values of the eigenvalues or eigenvectors, or the hash values may be input into a key generation function, such as a pseudorandom generator. In some cases, the key may be a quantized value of the channels on some REs (e.g., bitmap on which REs were indicated as part of the configuration).

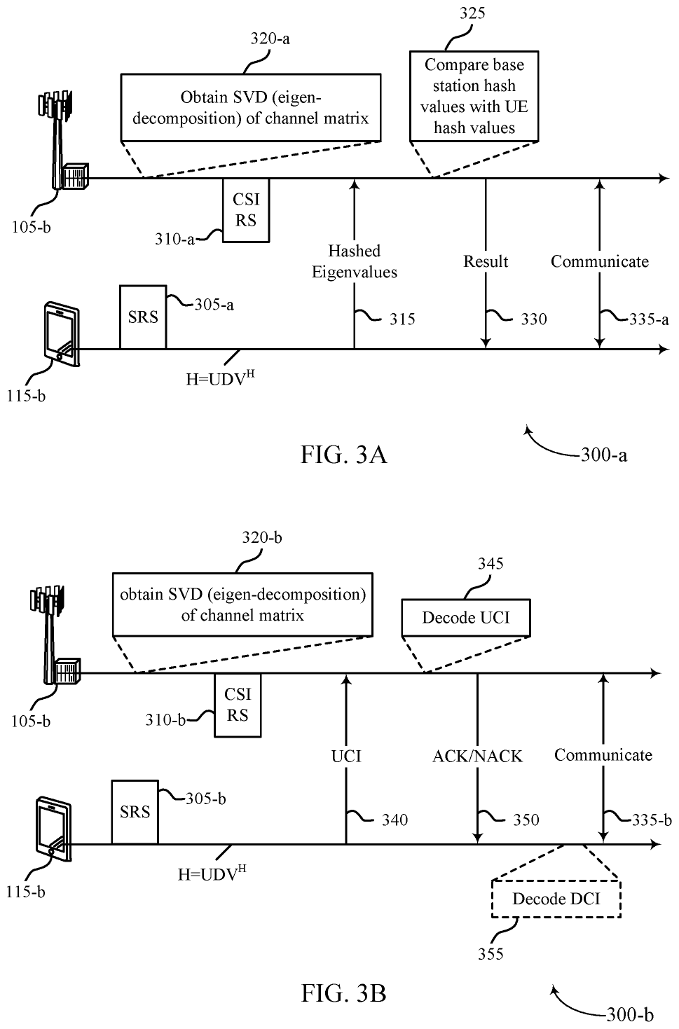

FIG. 3A and FIG. 3B illustrate examples of wireless communications timelines 300 that support physical layer security in wireless communications in accordance with aspects of the present disclosure. The wireless communications timelines 300 illustrate examples of communications between a UE 115-b and a base station 105-b, which may be examples of the corresponding devices described with respect to FIG. 1 and FIG. 2. Various aspects of techniques described with respect to FIG. 3 may be performed by devices other than base station 105-b and UE 115-b. For example, various aspects of the techniques described herein may be performed by two UEs 115 in a sidelink communication scenario.

In either wireless communications timeline 300-a or wireless communications timeline 300-b, the base station 105-b may transmit one or more control messages to the UE 115-b, and the one or more control messages may configure and/or activate the key generation procedure as described herein. For example, the one or more control messages may be examples of the configuration message 215 as described with respect to FIG. 2.

In either wireless communications timeline 300-a or wireless communications timeline 300-b, the UE 115-b may send a SRS 305 using resources configured by the base station 105-b. For example, the UE 115-b may transmit the SRS 305 using one or more first antennas of a plurality of antennas that are configured at the UE 115-b. At 320, the base station 105-b may estimate the channel to obtain one or more eigenvalues or eigenvectors corresponding to the SRS resources. For example, the base station 105-b may obtain SVD (eigen-decomposition) of the channel matrix of the SRS resources. The base station may input the eigenvalues or eigenvectors into a configured hash function. The base station 105-b may transmit a downlink reference signal, such as CSI-RS 310 to the UE 115-b, and the UE 115-b may receive the downlink reference signal using the same one or more antennas that were used to transmit the SRS (e.g., the same SRS resources or QCL resources). The downlink reference signal may be unprecoded or precoded using the computed eigenvectors. The UE 115-b may estimate the channel, H, to compute one or more eigenvalues or eigenvectors. For example, the UE 115-b may compute eigenvalues of one or more REs or RBs. In some examples, the UE 115-b may perform a linear or non-linear function and quantize the result to obtain the bits.

In wireless communications timeline 300-a, the UE 115-b transmits an indication of the eigenvalue or eigenvectors. For example, at 315, the UE 115-b may transmit a value resulting from a hash function that receives the eigenvalues or eigenvectors as input. At 325, the base station 105-b may compare the base station computed hash value to the UE computed hash value to determine whether the key generation procedure is successful. At 330, the base station 105-b may transmit an indication of the result of the comparison to the UE 115-b. In some cases, the indication of the result is a bit or flag in a DCI message or a ACK or NACK in a DCI message. In some examples, the hash value may be used as a key or as a seed to generate a key. In the same or alternative examples, the key is the quantized value of the channels on some REs that are configured as part of the security key generation procedure configuration. If the key generation procedure is successful, then at 335, the UE 115-b and the base station 105-b may communicate, and various fields may be secured using the security key.

In wireless communications timeline 300-b, after computing the eigenvalues or eigenvectors, the UE 115-b may compute a hash value using a hash function that receives the eigenvalues or eigenvectors as input. The hash value may be used to encode an UCI message. In this example, the UCI resources may be configured via RRC/MAC-CE as part of the key generation procedure configuration. Encoding of the UCI may include performing an exclusive or (XOR) operation with the hash value (or generated key) and the UCI data. The PUCCH resource used to convey the UCI may be signaled as part of the CSI-RS or SRS configuration. At 345, the base station may attempt to decode the UCI message 340. If the base station 105-b is able to decode (e.g., remove the secret key/hash value and CRC checks) and identifies an ACK (e.g., assuming that the UE 115-b and the base station 105-b agreed to sue PUCCH format 0 and agreed to send ACK sequences), then the base station 105-b determines that the key generation procedure is successful (e.g., the base station 105-b derived key matches the UE 115-b derived key). The UCI that is XORed with the hash value or security key may be before or after the CRC bits in the UCI message 340. In some cases, the base station 105-a may send a DCI message 350 confirming (ACK) or rejection (NACK) of the key generation procedure.

In some examples, the DCI message 350 may also be encoded using the hash value or security key. For example, the base station 105—a may XOR the DCI with the hash value or security key. In such cases, at 355, the UE 115-a may attempt to decode the DCI using its computed hash value or security key. This technique may provide a more robust security key generation procedure. Whether the DCI is encoded or not (e.g., with the security key or hash value), the UE 115-b and the base station 105-b may communicate, at 335-b, on physical channels that have fields that are secured using the hash value or security key.

In some cases, the key generation procedure is unsuccessful. For example, the channel conditions may change, the beam alignments may be inadequate, or the like. As such, the computed hash values may not match. In such cases, the base station 105-b and/or the UE 115-b may transmit a NACK. As such, the secret key generation procedure may be repeated until success (e.g., an ACK is transmitted and/or the same hash values are computed). The hash function may be similar to functions that are used in higher layers and cryptography schemes. In some cases, the hash function may be signaled as part of the security key generation procedure configuration or in a separate signaling sequence (e.g., RRC or MAC-CE). The hash function may be changed based on environments and/or conditions.

The generated security key may be used for various security purposes. In one example, fields in the DCI, such as redundancy version index, modulation and coding scheme (MCS) index, time domain resource allocation (TDRA) index, frequency domain resource allocation (FDRA) index, or a combination thereof, may be secured via the security key. In some examples, the security key or hash value may be used to generate a longer sequence of secure bits through a key derivation function (e.g., pseudo-random generator) where the generated key or hash value from the channel is a seed to secure an entire transmission (e.g., DCI transmission, PDSCH transmission, PUSCH transmission, PUCCH transmissions, PUSCH, transmissions, and MAC-CE messages) or portions thereof. In some examples, the value of the security key or hash value or portion thereof may be used to define a subset of search spaces and blind decoding/search parameters. For example, a first value of the security key may be associated with a first set of search spaces, and a second value of the security key may be associated with a second set of search spaces.

As described herein one or more eigenvalues or eigenvectors may be obtained by the base station 105-b and the UE 115-b. In some examples, the one or more eigenvalues or eigenvectors are obtained on some REs. In some cases, the one or more REs are indicated or configured via a bitmap. The REs may be contiguous or non-contiguous. Similarly, the one or more eigenvalues or eigenvectors may be obtained on contiguous or non-contiguous RBs. If using RBs, the values may be determined by averaging across REs of the RB, and the REs of the RBs may be indicated via a bitmap. In some cases, the one or more eigenvalues or eigenvectors may be obtained across a physical resource block group (PRG) or subband. In some cases, the resources of the PRG to use for eigenvalue eigenvector identification may be indicated via a bitmap. The PRG or subband may be contiguous or non-contiguous. A wideband radiofrequency band may also be used to obtain the one or more eigenvalues or eigenvectors, and the values may be obtained by averaging across all REs (or RBs) or portions thereof. In some cases, rather than using eigenvalues or eigenvectors, diagonal channels of the channel matrices across REs, RBs, PRGs, or wideband may be used. Similar signaling techniques may be used to indicate the resources to sue for the diagonal channels.

In some case, a function f( ) may be used to map the received channels, eigenvalues, eigenvectors, into an output. The function may be signaled between the UE 115-b and the base station 105-b (e.g., signaled via RRC or MAC-CE). This function may be known by other UEs in the coverage area, but may not produce the same result, as channel conditions may be dependent on the position and orientation of the UE 115 relative to the base station 105-b.

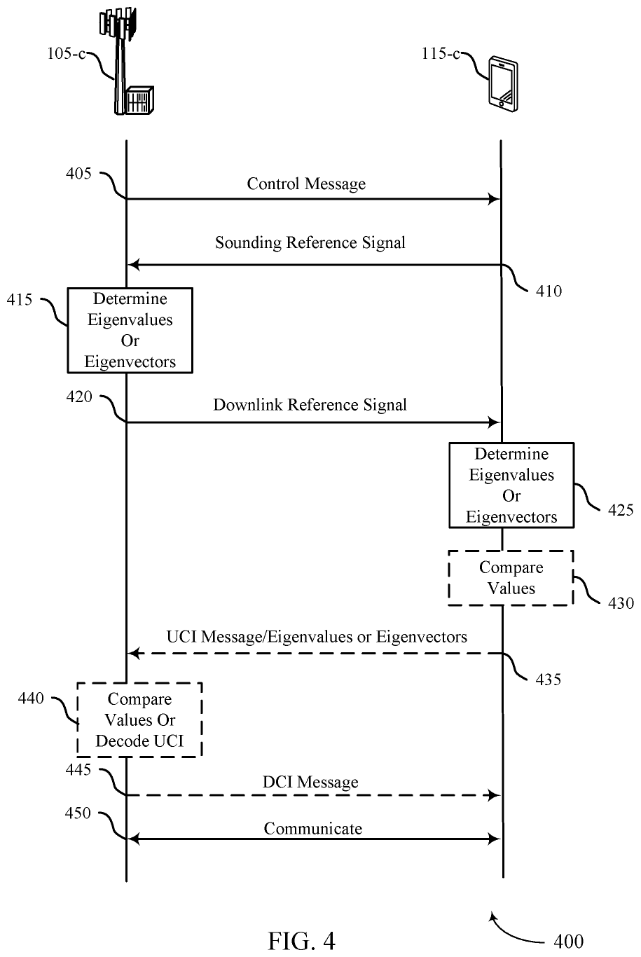

FIG. 4 illustrates an example of a process flow 400 that supports physical layer security in wireless communications in accordance with aspects of the present disclosure. In some examples, process flow 400 may implement aspects of wireless communications systems 100 and 200 as described with reference to FIGS. 1 and 2 and wireless communications timeliness 300 as described with respect to FIG. 3. Process flow 400 may include base station 105-c and UE 115-c, which may be examples of the corresponding devices described with respect to FIGS. 1 through 3. The process flow 400 may represent aspects of techniques performed by wireless devices as described with reference to FIGS. 1-10.

The process flow 400 illustrates an exemplary order of actions performed by base station 105-c and UE 115-c to support secure communications. In the following description of the process flow 400, the operations between base station 105-c and UE 115-c may be transmitted in a different order than the exemplary order shown, or the operations performed by base station 105-c and UE 115-c may be performed in different orders or at different times. Certain operations may also be omitted from the process flow 400, and/or other operations may be added to the process flow 400.

At 405, the base station 105-c may transmit a control message to UE 115-c. The control message may indicate a configuration for a security key generation procedure for communications between the base station 105-c and the UE 115-c. The control message may be an example of a RRC or MAC-CE message that includes configuration parameters for the security key generation procedure. The configuration parameters may include resources for the uplink and downlink reference signals. In some examples, the resources are QCL or correspond to the same TCI state. In some examples, a control message may be an example of a DCI or MAC-CE message that includes a trigger to establish the secure key extraction session (e.g., according to the security key generation procedure).

At 410, the UE 115-c may transmit, to the base station 105-c a SRS using one or more first antennas of a plurality of antennas. Transmission of the SRS may use one or more antennas (e.g., SRS resources) in accordance with the configuration transmitted from the base station 105-c via the control message.

At 415, the base station 105-c may determine one or more one or more eigenvalues or eigenvectors based at least in part on a channel estimation of a channel associated with the SRS. For example, the base station 105-c may determine a SVD (e.g., eigenvalue or eigenvector composition) of a channel matrix associated with the SRS. The one or more eigenvalues or eigenvectors may correspond to resources that are configured according to the configuration of the security key generation procedure. Resources may be contiguous or non-contiguous REs, contiguous or non-contiguous RBs, contiguous or non-contiguous PRGs, a wideband frequency band, or a combination thereof. The one or more eigenvalues or eigenvectors may be used as a basis for a security key. In some examples, the base station 105-c may compute hash value of the one or more eigenvalues or eigenvectors and use the hash value as the security key.

At 420, the base station 105-c may transmit, to the UE 115-c, a downlink reference signal in accordance with the configuration, and the UE 115-c may receive the downlink reference signal using the one or more first antennas in accordance with the configuration. The downlink reference signal may be an example of a CSI-RS. The downlink reference signal may be precoded or unprecoded.

At 425, the UE 115-c may determine one or more eigenvalues or eigenvectors based at least in part on a channel estimation of a channel associated with the downlink reference signal. For example, the UE 115-c may determine a SVD (e.g., eigenvalue or eigenvector composition) of a channel matrix using a linear or nonlinear function. In some examples, bits contained within the downlink reference signal may be obtained and quantized in order to determine eigenvalues or eigenvectors. The one or more eigenvalues or eigenvectors may be used as a basis for a security key. In some examples, the UE 115-c may compute hash value (e.g., using a hash function) of the one or more eigenvalues or eigenvectors and use the hash value as the security key.

The UE 115-c and the base station 105-c may use various techniques to determine whether the security key generation procedure is successful. In some cases, the base station 105-c may transmit an indication of the base station 105-c computed eigenvalues or eigenvectors to the UE 115-c. The indication may be a hash value of the eigenvalues or eigenvectors. The indication may be included in the transmission of the downlink reference signal at 420. In such cases, at 430, the UE 115-c may compare the base station computed eigenvalues or eigen vectors (e.g., hash values) to the UE computed eigenvalues or eigen vectors (e.g., hash value). If the values match, then the UE 115-a may transmit an indication (e.g., ACK) in an UCI message at 435.

In some examples, rather than comparing the values at the UE 115-c, at 435, the UE 115-c may transmit, to the base station 105-c an indication of the one or more eigenvalues or eigenvectors. The indication may be a hash value of the one or more eigenvalues or eigenvectors. The indication may be included in a UCI message. In such cases, at 440, the base station 105-c may compare the base station 105-c computed values (e.g., hash values) to the received UE 115-c computed values (e.g., hash values). In such cases, if the values are the same, then the base station 105-a may transmit an indication that the security key generation procedure was successful. For example, at 445, the base station 105-a may transmit a DCI message with an ACK.

In some cases, rather than or in addition to comparing the values by the UE 115-c or the base station 105-c, the UE 115-c may encode the UCI message transmitted at 435 using the security key or hash value computed based on the eigenvalues or eigenvectors. The UCI message may be XORed with the extracted key. In some examples, the PUCCH resource used for the UCI message could be signaled as part of CSI-RS and SRS configuration. In such cases, the base station 105-c may attempt to decode the UCI using the base station derived key or computed hash value. If the base station 105-c is able to decode the UCI, then the base station may determine that the security key generation procedure was successful and transmit an indication (e.g., in the DCI message at 445) to the UE 115-c. In some examples, the base station 105-c may transmit, to the UE 115-c the DCI message that is XORed with the security key bits or hash value. In some examples, the final DCI from base station 105-c is XORed with the extracted key for robust key sharing.

At 450, the UE 115-c and the base station 105-c may communicate via the communications secured using a security key derived using the one or more eigenvalues or eigenvectors. Various fields of various physical channels may be secured using the security key.

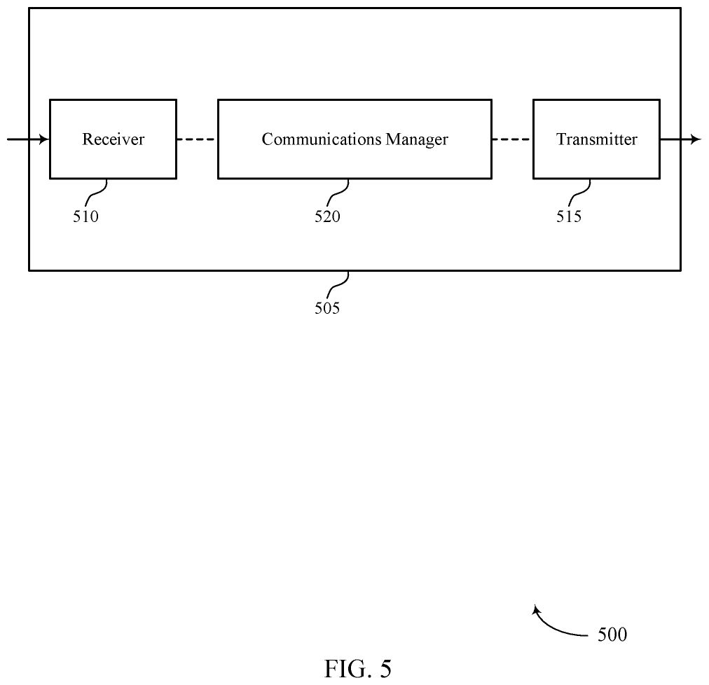

FIG. 5 shows a block diagram 500 of a device 505 that supports physical layer security in wireless communications in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to physical layer security in wireless communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to physical layer security in wireless communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of physical layer security in wireless communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a UE in accordance with examples as disclosed herein. For example, the communications manager 520 may be configured as or otherwise support a means for receiving, from a base station, a control message indicating a configuration for a security key generation procedure for communications between the UE and the base station. The communications manager 520 may be configured as or otherwise support a means for transmitting, to the base station, a sounding reference signal using one or more first antennas of a set of multiple antennas in accordance with the configuration. The communications manager 520 may be configured as or otherwise support a means for receiving, from the base station, a downlink reference signal using the one or more first antennas in accordance with the configuration. The communications manager 520 may be configured as or otherwise support a means for determining one or more eigenvalues or eigenvectors based on a channel estimation of a channel associated with the downlink reference signal. The communications manager 520 may be configured as or otherwise support a means for communicating, with the base station, via the communications secured using a security key derived using the one or more eigenvalues or eigenvectors.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reducing processing by implementing security features in the physical layer, thereby avoiding or limiting use of upper layers, with more processing overhead, for security purposes.

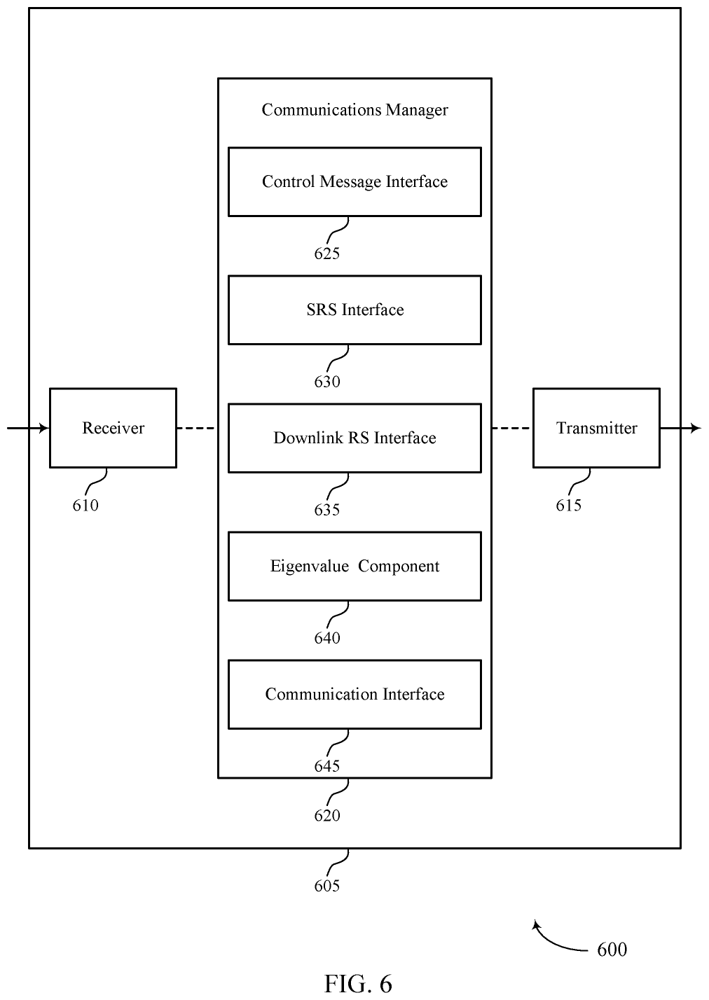

FIG. 6 shows a block diagram 600 of a device 605 that supports physical layer security in wireless communications in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to physical layer security in wireless communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to physical layer security in wireless communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of physical layer security in wireless communications as described herein. For example, the communications manager 620 may include a control message interface 625, an SRS interface 630, a downlink reference signal (RS) interface 635, an eigenvalue component 640, a communication interface 645, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. The control message interface 625 may be configured as or otherwise support a means for receiving, from a base station, a control message indicating a configuration for a security key generation procedure for communications between the UE and the base station. The SRS interface 630 may be configured as or otherwise support a means for transmitting, to the base station, a sounding reference signal using one or more first antennas of a set of multiple antennas in accordance with the configuration. The downlink RS interface 635 may be configured as or otherwise support a means for receiving, from the base station, a downlink reference signal using the one or more first antennas in accordance with the configuration. The eigenvalue component 640 may be configured as or otherwise support a means for determining one or more eigenvalues or eigenvectors based on a channel estimation of a channel associated with the downlink reference signal. The communication interface 645 may be configured as or otherwise support a means for communicating, with the base station, via the communications secured using a security key derived using the one or more eigenvalues or eigenvectors.

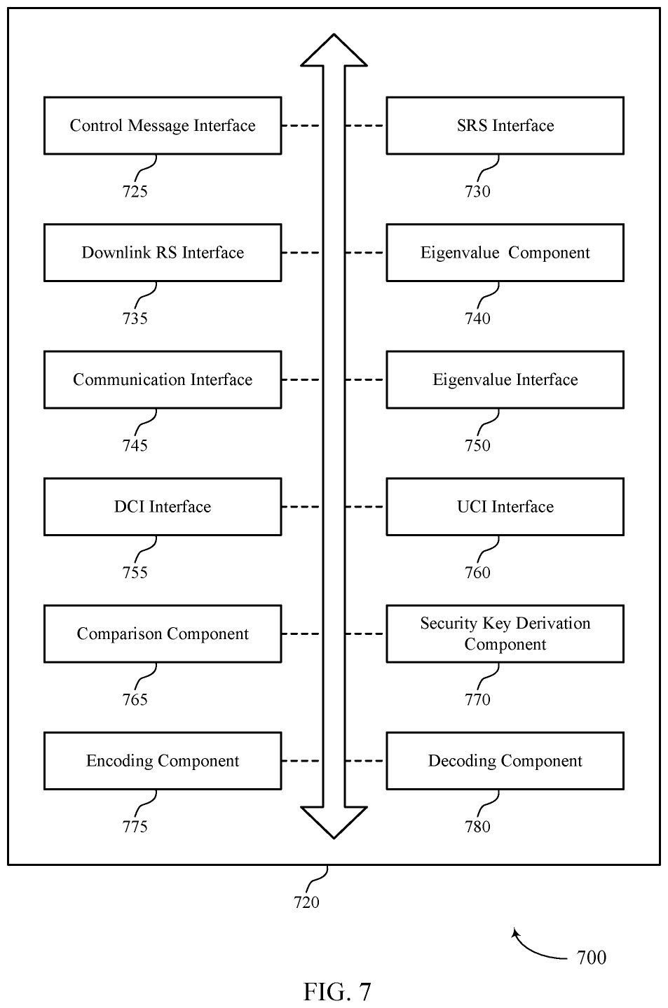

FIG. 7 shows a block diagram 700 of a communications manager 720 that supports physical layer security in wireless communications in accordance with aspects of the present disclosure. The communications manager 720 may be an example of aspects of a communications manager 520, a communications manager 620, or both, as described herein. The communications manager 720, or various components thereof, may be an example of means for performing various aspects of physical layer security in wireless communications as described herein. For example, the communications manager 720 may include a control message interface 725, an SRS interface 730, a downlink RS interface 735, an eigenvalue component 740, a communication interface 745, an eigenvalue interface 750, a DCI interface 755, a UCI interface 760, a comparison component 765, a security key derivation component 770, an encoding component 775, a decoding component 780, or any combination thereof. Each of these components may communicate, directly or indirectly, with one another (e.g., via one or more buses).

The communications manager 720 may support wireless communications at a UE in accordance with examples as disclosed herein. The control message interface 725 may be configured as or otherwise support a means for receiving, from a base station, a control message indicating a configuration for a security key generation procedure for communications between the UE and the base station. The SRS interface 730 may be configured as or otherwise support a means for transmitting, to the base station, a sounding reference signal using one or more first antennas of a set of multiple antennas in accordance with the configuration. The downlink RS interface 735 may be configured as or otherwise support a means for receiving, from the base station, a downlink reference signal using the one or more first antennas in accordance with the configuration. The eigenvalue component 740 may be configured as or otherwise support a means for determining one or more eigenvalues or eigenvectors based on a channel estimation of a channel associated with the downlink reference signal. The communication interface 745 may be configured as or otherwise support a means for communicating, with the base station, via the communications secured using a security key derived using the one or more eigenvalues or eigenvectors.

In some examples, the eigenvalue interface 750 may be configured as or otherwise support a means for transmitting, to the base station, an indication of the one or more eigenvalues or eigenvectors. In some examples, the DCI interface 755 may be configured as or otherwise support a means for receiving, from the base station, a downlink control information message that indicates a security key derivation status, where the UE communicates with the base station based on the security key derivation status.

In some examples, to support transmitting the indication of the one or more eigenvalues or eigenvectors, the eigenvalue interface 750 may be configured as or otherwise support a means for transmitting a hash value of the one or more eigenvalues or eigenvectors.

In some examples, to support communicating with the base station, the UCI interface 760 may be configured as or otherwise support a means for transmitting, to the base station, an uplink control information message that is encoded using the security key.

In some examples, to support transmitting the uplink control information message, the UCI interface 760 may be configured as or otherwise support a means for transmitting the uplink control information message that includes an acknowledgement corresponding to the downlink reference signal.

In some examples, the DCI interface 755 may be configured as or otherwise support a means for receiving, from the base station, a downlink control information message that indicates a security key derivation status, where the UE communicates with the base station based on the security key derivation status.

In some examples, to support receiving the downlink control information message, the DCI interface 755 may be configured as or otherwise support a means for receiving the downlink control information message that is encoded using the security key derived at the base station. In some examples, to support receiving the downlink control information message, the decoding component 780 may be configured as or otherwise support a means for decoding the downlink control information message using the security key derived by the UE.

In some examples, the eigenvalue interface 750 may be configured as or otherwise support a means for receiving, via the downlink reference signal, an indication of base station computed one or more eigenvalues or eigenvectors. In some examples, the comparison component 765 may be configured as or otherwise support a means for comparing, the one or more eigenvalues or eigenvectors computed by the UE to the base station computed one or more eigenvalues or eigenvectors. In some examples, the security key derivation component 770 may be configured as or otherwise support a means for deriving the security key using the one or more eigenvalues or eigenvectors or both based on a result of the comparing.

In some examples, the security key derivation component 770 may be configured as or otherwise support a means for deriving the security key using a quantized value of the one or more eigenvalues or eigenvectors in accordance with the configuration.

In some examples, the security key derivation component 770 may be configured as or otherwise support a means for deriving the security key using the one or more eigenvalues or eigenvectors using a hash function, a security key derivation function, or a combination thereof, in accordance with the configuration.

In some examples, to support receiving the control message, the control message interface 725 may be configured as or otherwise support a means for receiving an indication of one or more quantization levels used to determine a value for the one or more eigenvalues or eigenvectors, where the value is used to derive the security key.

In some examples, the security key derivation component 770 may be configured as or otherwise support a means for deriving the security key using a key derivation function in accordance with the configuration, where the UE communicates with the base station using a physical downlink shared channel transmission, a physical uplink shared channel transmission, a medium access control layer control element message, a physical uplink control channel transmission, or a combination thereof that is secured using the security key.

In some examples, to support determining the one or more eigenvalues or eigenvectors, the eigenvalue component 740 may be configured as or otherwise support a means for determining the one or more eigenvalues or eigenvectors using one or more resources in accordance with the configuration.

In some examples, the one or more resources are contiguous or non-contiguous resource elements, contiguous or non-contiguous resource blocks, contiguous or non-contiguous physical resource block groups, a wideband frequency band, or a combination thereof.

In some examples, to support receiving the control message, the control message interface 725 may be configured as or otherwise support a means for receiving the control message that configures an uplink resource for transmitting the sounding reference signal and a downlink resource for receiving the downlink reference signal, where the uplink resource is quasi-co located with the downlink resource.

In some examples, to support receiving the control message, the control message interface 725 may be configured as or otherwise support a means for receiving the control message that configures a bandwidth part for transmitting the sounding reference signal and receiving the downlink reference signal, where the sounding reference signal is transmitted and the downlink reference signal is received on the bandwidth part in accordance with the configuration.

In some examples, to support communicating with the base station, the encoding component 775 may be configured as or otherwise support a means for encoding one or more fields in a physical uplink control channel transmission, a physical uplink shared channel transmission, or both, using the security key.

In some examples, to support communicating with the base station, the decoding component 780 may be configured as or otherwise support a means for decoding one or more fields in a downlink control information message using the security key.

In some examples, the one or more fields include a redundancy value index, a modulation and coding scheme index, a time domain resource assignment index, a frequency domain resource assignment index, or a combination thereof.

In some examples, the DCI interface 755 may be configured as or otherwise support a means for determining, based on a value of the security key, a subset of search spaces of a set of multiple search spaces configured at the UE or one or more blind search parameters. In some examples, the DCI interface 755 may be configured as or otherwise support a means for performing blind decoding in the subset of search spaces, using the one or more blind search parameters, or both.

In some examples, the eigenvalue component 740 may be configured as or otherwise support a means for determining that the one or more eigenvalues or eigenvectors determined at the UE are different from base station computed one or more eigenvalues or eigenvectors. In some examples, the SRS interface 730 may be configured as or otherwise support a means for retransmitting the one or more sounding reference signal based on the determining.

In some examples, to support receiving the downlink reference signal, the downlink RS interface 735 may be configured as or otherwise support a means for receiving a channel state information reference signal.

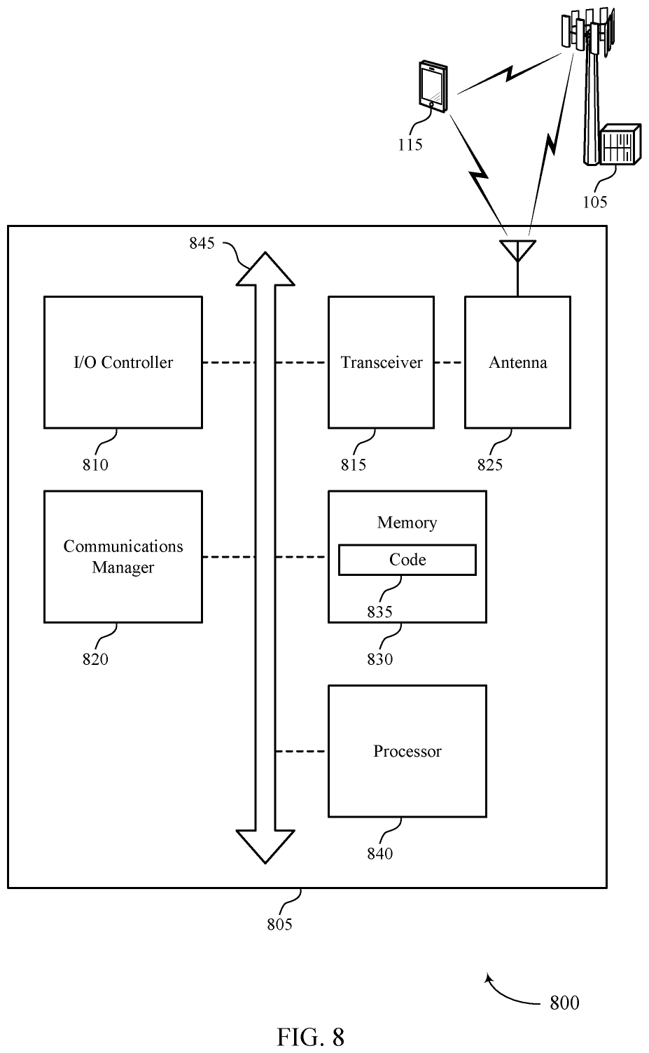

FIG. 8 shows a diagram of a system 800 including a device 805 that supports physical layer security in wireless communications in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting physical layer security in wireless communications). For example, the device 805 or a component of the device 805 may include a processor 840 and memory 830 coupled to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving, from a base station, a control message indicating a configuration for a security key generation procedure for communications between the UE and the base station. The communications manager 820 may be configured as or otherwise support a means for transmitting, to the base station, a sounding reference signal using one or more first antennas of a set of multiple antennas in accordance with the configuration. The communications manager 820 may be configured as or otherwise support a means for receiving, from the base station, a downlink reference signal using the one or more first antennas in accordance with the configuration. The communications manager 820 may be configured as or otherwise support a means for determining one or more eigenvalues or eigenvectors based on a channel estimation of a channel associated with the downlink reference signal. The communications manager 820 may be configured as or otherwise support a means for communicating, with the base station, via the communications secured using a security key derived using the one or more eigenvalues or eigenvectors.

By including or configuring the communications manager 820 in accordance with examples as described herein, the device 805 may support techniques for improved security in a wireless communications system by adding additional security features at the physical layer.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of physical layer security in wireless communications as described herein, or the processor 840 and the memory 830 may be otherwise configured to perform or support such operations.

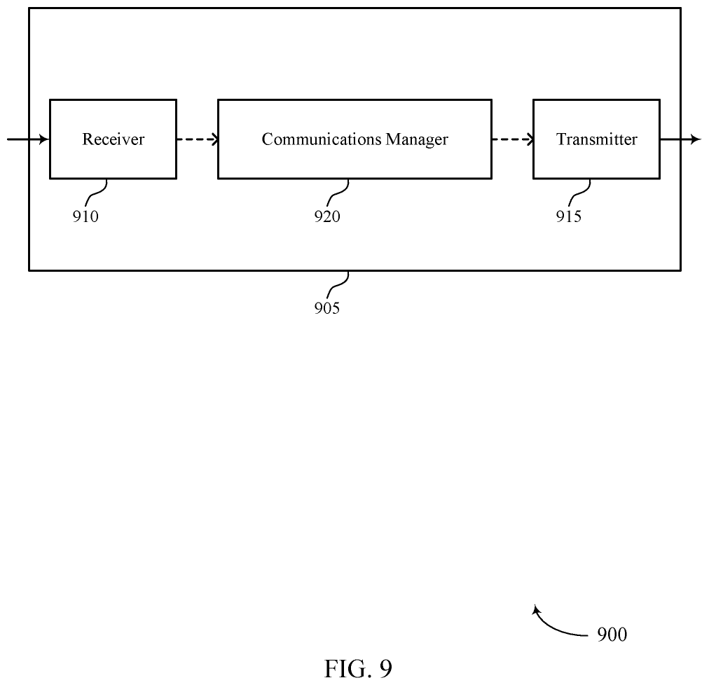

FIG. 9 shows a block diagram 900 of a device 905 that supports physical layer security in wireless communications in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to physical layer security in wireless communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to physical layer security in wireless communications). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of physical layer security in wireless communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a UE, a control message indicating a configuration for a security key generation procedure for communications between the UE and the base station. The communications manager 920 may be configured as or otherwise support a means for receiving, from the UE, a sounding reference signal in accordance with the configuration. The communications manager 920 may be configured as or otherwise support a means for determining one or more one or more eigenvalues or eigenvectors based on a channel estimation of a channel associated with the sounding reference signal. The communications manager 920 may be configured as or otherwise support a means for transmitting, to the UE, a downlink reference signal in accordance with the configuration. The communications manager 920 may be configured as or otherwise support a means for communicating, with the UE, via the communications secured using a security key derived using the one or more eigenvalues or eigenvectors.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for reducing processing by implementing security features in the physical layer, thereby avoiding or limiting use of upper layers, with more processing overhead, for security purposes

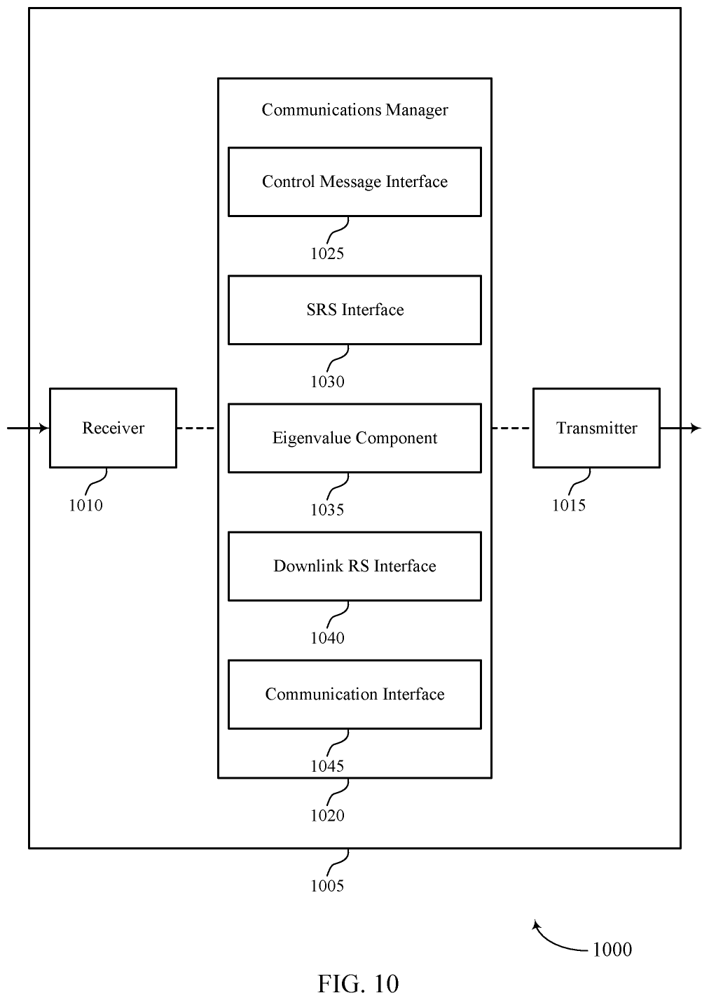

FIG. 10 shows a block diagram 1000 of a device 1005 that supports physical layer security in wireless communications in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to physical layer security in wireless communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to physical layer security in wireless communications). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of physical layer security in wireless communications as described herein. For example, the communications manager 1020 may include a control message interface 1025, an SRS interface 1030, an eigenvalue component 1035, a downlink RS interface 1040, a communication interface 1045, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The control message interface 1025 may be configured as or otherwise support a means for transmitting, to a UE, a control message indicating a configuration for a security key generation procedure for communications between the UE and the base station. The SRS interface 1030 may be configured as or otherwise support a means for receiving, from the UE, a sounding reference signal in accordance with the configuration. The eigenvalue component 1035 may be configured as or otherwise support a means for determining one or more one or more eigenvalues or eigenvectors based on a channel estimation of a channel associated with the sounding reference signal. The downlink RS interface 1040 may be configured as or otherwise support a means for transmitting, to the UE, a downlink reference signal in accordance with the configuration. The communication interface 1045 may be configured as or otherwise support a means for communicating, with the UE, via the communications secured using a security key derived using the one or more eigenvalues or eigenvectors.

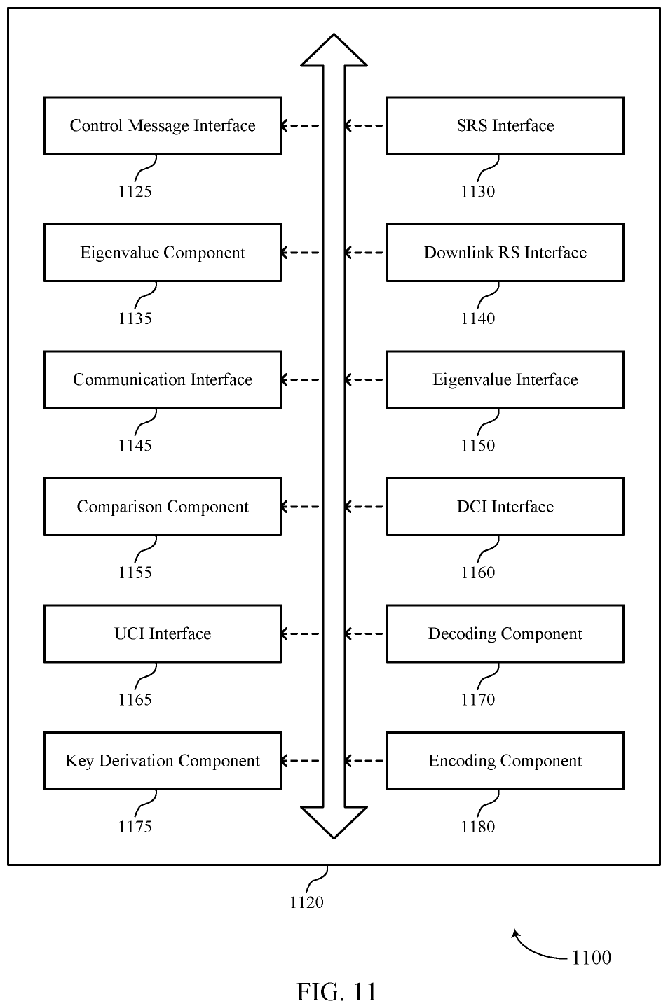

FIG. 11 shows a block diagram 1100 of a communications manager 1120 that supports physical layer security in wireless communications in accordance with aspects of the present disclosure. The communications manager 1120 may be an example of aspects of a communications manager 920, a communications manager 1020, or both, as described herein. The communications manager 1120, or various components thereof, may be an example of means for performing various aspects of physical layer security in wireless communications as described herein. For example, the communications manager 1120 may include a control message interface 1125, an SRS interface 1130, an eigenvalue component 1135, a downlink RS interface 1140, a communication interface 1145, an eigenvalue interface 1150, a comparison component 1155, a DCI interface 1160, a UCI interface 1165, a decoding component 1170, a key derivation component 1175, an encoding component 1180, or any combination thereof. Each of these components may communicate, directly or indirectly, with one another (e.g., via one or more buses).

The communications manager 1120 may support wireless communications at a base station in accordance with examples as disclosed herein. The control message interface 1125 may be configured as or otherwise support a means for transmitting, to a UE, a control message indicating a configuration for a security key generation procedure for communications between the UE and the base station. The SRS interface 1130 may be configured as or otherwise support a means for receiving, from the UE, a sounding reference signal in accordance with the configuration. The eigenvalue component 1135 may be configured as or otherwise support a means for determining one or more one or more eigenvalues or eigenvectors based on a channel estimation of a channel associated with the sounding reference signal. The downlink RS interface 1140 may be configured as or otherwise support a means for transmitting, to the UE, a downlink reference signal in accordance with the configuration. The communication interface 1145 may be configured as or otherwise support a means for communicating, with the UE, via the communications secured using a security key derived using the one or more eigenvalues or eigenvectors.

In some examples, the eigenvalue interface 1150 may be configured as or otherwise support a means for receiving, from the UE, an indication of UE computed one or more eigenvalues or eigenvectors. In some examples, the comparison component 1155 may be configured as or otherwise support a means for comparing, the one or more eigenvalues or eigenvectors computed by the base station to the UE computed one or more eigenvalues or eigenvectors. In some examples, the DCI interface 1160 may be configured as or otherwise support a means for transmitting, to the UE, a downlink control information message at indicates a security key derivation status resulting from the comparing, where the UE communicates with the base station based on the security key derivation status.

In some examples, to support receiving the indication of the UE computed one or more eigenvalues or eigenvectors, the eigenvalue interface 1150 may be configured as or otherwise support a means for receiving a hash value of the UE computed one or more eigenvalues or eigenvectors, where the base station compares the hash value of the UE computed one or more eigenvalues or eigenvectors to a hash value of the one or more eigenvalues or eigenvectors computed by the base station.

In some examples, to support transmitting the downlink control information message, the DCI interface 1160 may be configured as or otherwise support a means for transmitting the downlink control information message that is encoded with the security key to indicate the security key derivation status.

In some examples, the UCI interface 1165 may be configured as or otherwise support a means for receiving, from the UE, an uplink control information message that is encoded using the security key derived at the UE. In some examples, the decoding component 1170 may be configured as or otherwise support a means for decoding the uplink control information message using the security key.

In some examples, the uplink control information message includes an acknowledgement corresponding to the downlink reference signal.

In some examples, the eigenvalue interface 1150 may be configured as or otherwise support a means for transmitting, to the UE, an indication of the one or more eigenvalues or eigenvectors computed by the base station.

In some examples, to support transmitting the indication of the one or more eigenvalues or eigenvectors, the eigenvalue interface 1150 may be configured as or otherwise support a means for transmitting a hash value of the one or more eigenvalues or eigenvectors.

In some examples, the key derivation component 1175 may be configured as or otherwise support a means for deriving the security key using a quantized value of the one or more eigenvalues or eigenvectors in accordance with the configuration.

In some examples, the key derivation component 1175 may be configured as or otherwise support a means for deriving the security key using the one or more eigenvalues or eigenvectors using a hash function, a security key derivation function, or a combination thereof, in accordance with the configuration.

In some examples, the control message interface 1125 may be configured as or otherwise support a means for transmitting, to the UE, an indication of one or more quantization levels used to determine a value using the one or more eigenvalues or eigenvectors, where the value is used to derive the security key.

In some examples, the key derivation component 1175 may be configured as or otherwise support a means for deriving the security key using a pseudo-random generator in accordance with the configuration, where the base station communicates with the UE using a physical downlink shared channel transmission, a physical uplink shared channel transmission, a medium access control layer control element message, a physical uplink control channel transmission, or a combination thereof that is secured using the security key.

In some examples, to support determining the one or more eigenvalues or eigenvectors, the eigenvalue component 1135 may be configured as or otherwise support a means for determining the one or more eigenvalues or eigenvectors using one or more resources in accordance with the configuration.

In some examples, the one or more resources are contiguous or non-contiguous resource elements, contiguous or non-contiguous resource blocks, contiguous or non-contiguous physical resource block groups, a wideband frequency band, or a combination thereof.

In some examples, to support transmitting the control message, the control message interface 1125 may be configured as or otherwise support a means for transmitting the control message that configures an uplink resource for receiving the sounding reference signal and a downlink resource for transmitting the downlink reference signal, where the uplink resource is quasi-co located with the downlink resource.

In some examples, to support transmitting the control message, the control message interface 1125 may be configured as or otherwise support a means for transmitting the control message that configures a bandwidth part for receiving the sounding reference signal and transmitting the downlink reference signal, where the sounding reference signal is received and the downlink reference signal is transmitted on the bandwidth part in accordance with the configuration.

In some examples, to support communicating with the UE, the decoding component 1170 may be configured as or otherwise support a means for decoding one or more fields a physical uplink control channel transmission, a physical uplink shared channel transmission, or both, using the security key.

In some examples, to support communicating with the base station, the encoding component 1180 may be configured as or otherwise support a means for encoding one or more fields in a downlink control information message using the security key.

In some examples, the one or more fields include a redundancy value index, a modulation and coding scheme index, a time domain resource assignment index, a frequency domain resource assignment index, or a combination thereof.

In some examples, the DCI interface 1160 may be configured as or otherwise support a means for determining, based on a value of the security key, a subset of search spaces of a set of multiple search spaces configured at the UE or one or more blind search parameters. In some examples, the DCI interface 1160 may be configured as or otherwise support a means for transmitting a downlink control information message in the subset of search spaces, in accordance with the one or more blind search parameters, or both.

In some examples, the eigenvalue interface 1150 may be configured as or otherwise support a means for determining that the one or more eigenvalues or eigenvectors determined at the base station are different from UE computed one or more eigenvalues or eigenvectors. In some examples, the SRS interface 1130 may be configured as or otherwise support a means for receiving a retransmission of the sounding reference signal based on the determining.

In some examples, to support transmitting the downlink reference signal, the downlink RS interface 1140 may be configured as or otherwise support a means for transmitting a channel state information reference signal.

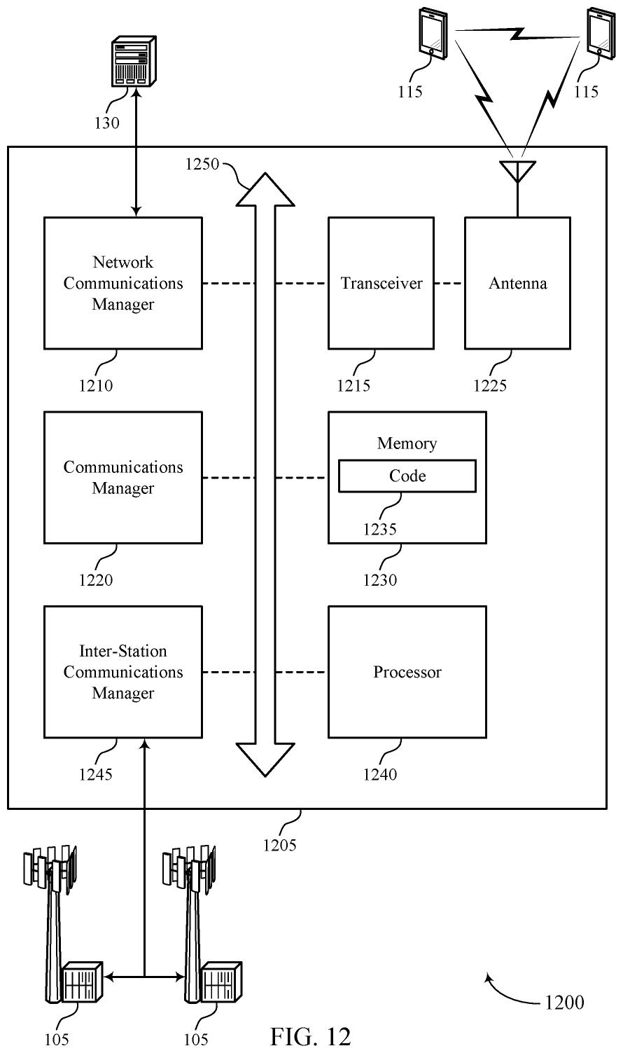

FIG. 12 shows a diagram of a system 1200 including a device 1205 that supports physical layer security in wireless communications in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting physical layer security in wireless communications). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a UE, a control message indicating a configuration for a security key generation procedure for communications between the UE and the base station. The communications manager 1220 may be configured as or otherwise support a means for receiving, from the UE, a sounding reference signal in accordance with the configuration. The communications manager 1220 may be configured as or otherwise support a means for determining one or more one or more eigenvalues or eigenvectors based on a channel estimation of a channel associated with the sounding reference signal. The communications manager 1220 may be configured as or otherwise support a means for transmitting, to the UE, a downlink reference signal in accordance with the configuration. The communications manager 1220 may be configured as or otherwise support a means for communicating, with the UE, via the communications secured using a security key derived using the one or more eigenvalues or eigenvectors.

By including or configuring the communications manager 1220 in accordance with examples as described herein, the device 1205 may support techniques for improved security in a wireless communications system by adding additional security features at the physical layer.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of physical layer security in wireless communications as described herein, or the processor 1240 and the memory 1230 may be otherwise configured to perform or support such operations.

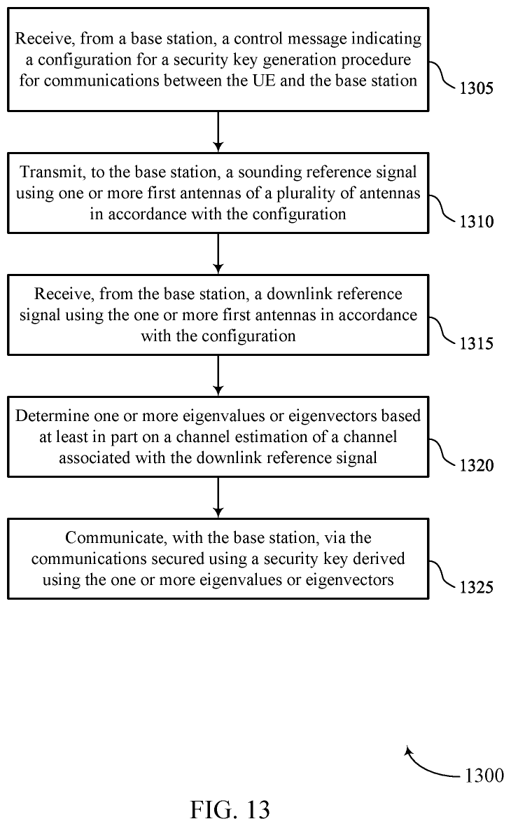

FIG. 13 shows a flowchart illustrating a method 1300 that supports physical layer security in wireless communications in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, a control message indicating a configuration for a security key generation procedure for communications between the UE and the base station. The operations of 1305 may be performed in accordance with examples as disclosed herein. In some examples, aspects of the operations of 1305 may be performed by a control message interface 725 as described with reference to FIG. 7.

At 1310, the method may include transmitting, to the base station, a sounding reference signal using one or more first antennas of a set of multiple antennas in accordance with the configuration. The operations of 1310 may be performed in accordance with examples as disclosed herein. In some examples, aspects of the operations of 1310 may be performed by an SRS interface 730 as described with reference to FIG. 7.

At 1315, the method may include receiving, from the base station, a downlink reference signal using the one or more first antennas in accordance with the configuration. The operations of 1315 may be performed in accordance with examples as disclosed herein. In some examples, aspects of the operations of 1315 may be performed by a downlink RS interface 735 as described with reference to FIG. 7.

At 1320, the method may include determining one or more eigenvalues or eigenvectors based on a channel estimation of a channel associated with the downlink reference signal. The operations of 1320 may be performed in accordance with examples as disclosed herein. In some examples, aspects of the operations of 1320 may be performed by an eigenvalue component 740 as described with reference to FIG. 7.

At 1325, the method may include communicating, with the base station, via the communications secured using a security key derived using the one or more eigenvalues or eigenvectors. The operations of 1325 may be performed in accordance with examples as disclosed herein. In some examples, aspects of the operations of 1325 may be performed by a communication interface 745 as described with reference to FIG. 7.

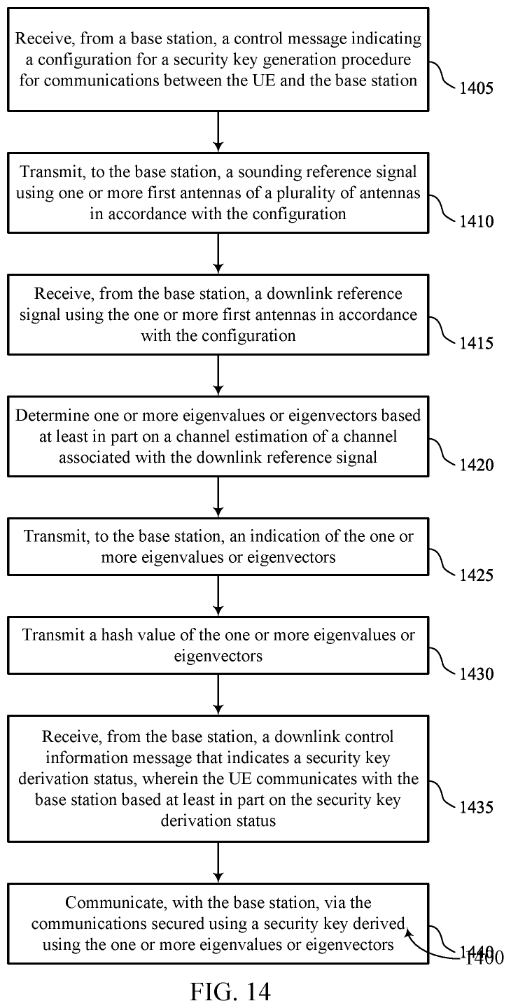

FIG. 14 shows a flowchart illustrating a method 1400 that supports physical layer security in wireless communications in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, a control message indicating a configuration for a security key generation procedure for communications between the UE and the base station. The operations of 1405 may be performed in accordance with examples as disclosed herein. In some examples, aspects of the operations of 1405 may be performed by a control message interface 725 as described with reference to FIG. 7.

At 1410, the method may include transmitting, to the base station, a sounding reference signal using one or more first antennas of a set of multiple antennas in accordance with the configuration. The operations of 1410 may be performed in accordance with examples as disclosed herein. In some examples, aspects of the operations of 1410 may be performed by an SRS interface 730 as described with reference to FIG. 7.

At 1415, the method may include receiving, from the base station, a downlink reference signal using the one or more first antennas in accordance with the configuration. The operations of 1415 may be performed in accordance with examples as disclosed herein. In some examples, aspects of the operations of 1415 may be performed by a downlink RS interface 735 as described with reference to FIG. 7.

At 1420, the method may include transmitting, to the base station, an indication of the one or more eigenvalues or eigenvectors. The operations of 1420 may be performed in accordance with examples as disclosed herein. In some examples, aspects of the operations of 1420 may be performed by an eigenvalue interface 750 as described with reference to FIG. 7.

At 1425, the method may include determining one or more eigenvalues or eigenvectors based on a channel estimation of a channel associated with the downlink reference signal. The operations of 1425 may be performed in accordance with examples as disclosed herein. In some examples, aspects of the operations of 1425 may be performed by an eigenvalue component 740 as described with reference to FIG. 7.

At 1430, the method may include transmitting a hash value of the one or more eigenvalues or eigenvectors. The operations of 1430 may be performed in accordance with examples as disclosed herein. In some examples, aspects of the operations of 1430 may be performed by an eigenvalue interface 750 as described with reference to FIG. 7.

At 1435, the method may include receiving, from the base station, a downlink control information message that indicates a security key derivation status, where the UE communicates with the base station based on the security key derivation status. The operations of 1435 may be performed in accordance with examples as disclosed herein. In some examples, aspects of the operations of 1435 may be performed by a DCI interface 755 as described with reference to FIG. 7.

At 1440, the method may include communicating, with the base station, via the communications secured using a security key derived using the one or more eigenvalues or eigenvectors. The operations of 1440 may be performed in accordance with examples as disclosed herein. In some examples, aspects of the operations of 1440 may be performed by a communication interface 745 as described with reference to FIG. 7.

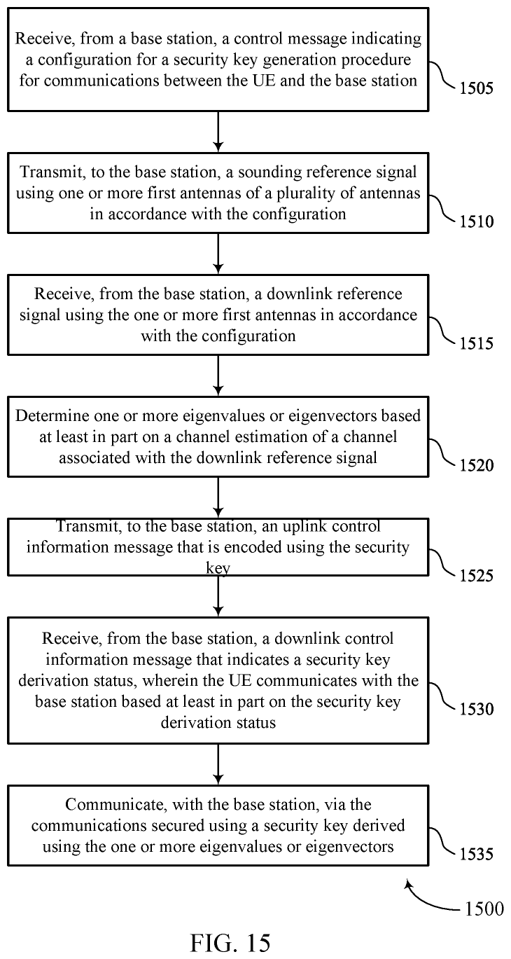

FIG. 15 shows a flowchart illustrating a method 1500 that supports physical layer security in wireless communications in accordance with aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1505, the method may include receiving, from a base station, a control message indicating a configuration for a security key generation procedure for communications between the UE and the base station. The operations of 1505 may be performed in accordance with examples as disclosed herein. In some examples, aspects of the operations of 1505 may be performed by a control message interface 725 as described with reference to FIG. 7.

At 1510, the method may include transmitting, to the base station, a sounding reference signal using one or more first antennas of a set of multiple antennas in accordance with the configuration. The operations of 1510 may be performed in accordance with examples as disclosed herein. In some examples, aspects of the operations of 1510 may be performed by an SRS interface 730 as described with reference to FIG. 7.

At 1515, the method may include receiving, from the base station, a downlink reference signal using the one or more first antennas in accordance with the configuration. The operations of 1515 may be performed in accordance with examples as disclosed herein. In some examples, aspects of the operations of 1515 may be performed by a downlink RS interface 735 as described with reference to FIG. 7.

At 1520, the method may include determining one or more eigenvalues or eigenvectors based on a channel estimation of a channel associated with the downlink reference signal. The operations of 1520 may be performed in accordance with examples as disclosed herein. In some examples, aspects of the operations of 1520 may be performed by an eigenvalue component 740 as described with reference to FIG. 7.

At 1525, the method may include transmitting, to the base station, an uplink control information message that is encoded using the security key. The operations of 1525 may be performed in accordance with examples as disclosed herein. In some examples, aspects of the operations of 1525 may be performed by a UCI interface 760 as described with reference to FIG. 7.

At 1530, the method may include receiving, from the base station, a downlink control information message that indicates a security key derivation status, where the UE communicates with the base station based on the security key derivation status. The operations of 1530 may be performed in accordance with examples as disclosed herein. In some examples, aspects of the operations of 1530 may be performed by a DCI interface 755 as described with reference to FIG. 7.

At 1535, the method may include communicating, with the base station, via the communications secured using a security key derived using the one or more eigenvalues or eigenvectors. The operations of 1535 may be performed in accordance with examples as disclosed herein. In some examples, aspects of the operations of 1535 may be performed by a communication interface 745 as described with reference to FIG. 7.

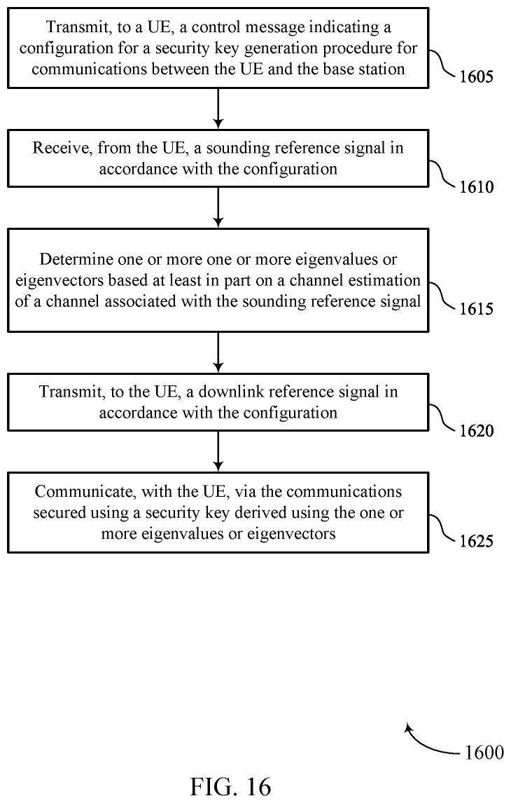

FIG. 16 shows a flowchart illustrating a method 1600 that supports physical layer security in wireless communications in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting, to a UE, a control message indicating a configuration for a security key generation procedure for communications between the UE and the base station. The operations of 1605 may be performed in accordance with examples as disclosed herein. In some examples, aspects of the operations of 1605 may be performed by a control message interface 1125 as described with reference to FIG. 11.

At 1610, the method may include receiving, from the UE, a sounding reference signal in accordance with the configuration. The operations of 1610 may be performed in accordance with examples as disclosed herein. In some examples, aspects of the operations of 1610 may be performed by an SRS interface 1130 as described with reference to FIG. 11.

At 1615, the method may include determining one or more one or more eigenvalues or eigenvectors based on a channel estimation of a channel associated with the sounding reference signal. The operations of 1615 may be performed in accordance with examples as disclosed herein. In some examples, aspects of the operations of 1615 may be performed by an eigenvalue component 1135 as described with reference to FIG. 11.

At 1620, the method may include transmitting, to the UE, a downlink reference signal in accordance with the configuration. The operations of 1620 may be performed in accordance with examples as disclosed herein. In some examples, aspects of the operations of 1620 may be performed by a downlink RS interface 1140 as described with reference to FIG. 11.

At 1625, the method may include communicating, with the UE, via the communications secured using a security key derived using the one or more eigenvalues or eigenvectors. The operations of 1625 may be performed in accordance with examples as disclosed herein. In some examples, aspects of the operations of 1625 may be performed by a communication interface 1145 as described with reference to FIG. 11.

The following provides an overview of aspects of the present disclosure:

Aspect 1: A method for wireless communications at a UE, comprising: receiving, from a base station, a control message indicating a configuration for a security key generation procedure for communications between the UE and the base station; transmitting, to the base station, a sounding reference signal using one or more first antennas of a plurality of antennas in accordance with the configuration; receiving, from the base station, a downlink reference signal using the one or more first antennas in accordance with the configuration; determining one or more eigenvalues or eigenvectors based at least in part on a channel estimation of a channel associated with the downlink reference signal; and communicating, with the base station, via the communications secured using a security key derived using the one or more eigenvalues or eigenvectors.

Aspect 2: The method of aspect 1, further comprising: transmitting, to the base station, an indication of the one or more eigenvalues or eigenvectors; and receiving, from the base station, a downlink control information message that indicates a security key derivation status, wherein the UE communicates with the base station based at least in part on the security key derivation status.

Aspect 3: The method of aspect 2, wherein transmitting the indication of the one or more eigenvalues or eigenvectors comprises: transmitting a hash value of the one or more eigenvalues or eigenvectors.

Aspect 4: The method of any of aspects 1 through 3,wherein communicating with the base station comprises: transmitting, to the base station, an uplink control information message that is encoded using the security key.

Aspect 5: The method of aspect 4, wherein transmitting the uplink control information message comprises: transmitting the uplink control information message that includes an acknowledgement corresponding to the downlink reference signal.

Aspect 6: The method of any of aspects 4 through 5, further comprising: receiving, from the base station, a downlink control information message that indicates a security key derivation status, wherein the UE communicates with the base station based at least in part on the security key derivation status.

Aspect 7: The method of aspect 6, wherein receiving the downlink control information message comprises: receiving the downlink control information message that is encoded using the security key derived at the base station; and decoding the downlink control information message using the security key derived by the UE.

Aspect 8: The method of any of aspects 1 through 7, further comprising: receiving, via the downlink reference signal, an indication of base station computed one or more eigenvalues or eigenvectors; comparing, the one or more eigenvalues or eigenvectors computed by the UE to the base station computed one or more eigenvalues or eigenvectors; and deriving the security key using the one or more eigenvalues or eigenvectors based at least in part on a result of the comparing.

Aspect 9: The method of any of aspects 1 through 8, further comprising: deriving the security key using a quantized value of the one or more eigenvalues or eigenvectors in accordance with the configuration.

Aspect 10: The method of any of aspects 1 through 9, further comprising: deriving the security key using the one or more eigenvalues or eigenvectors using a hash function, a security key derivation function, or a combination thereof, in accordance with the configuration.

Aspect 11: The method of any of aspects 1 through 10, wherein receiving the control message comprises: receiving an indication of one or more quantization levels used to determine a value for the one or more eigenvalues or eigenvectors, wherein the value is used to derive the security key.

Aspect 12: The method of any of aspects 1 through 11, further comprising: deriving the security key using a key derivation function in accordance with the configuration, wherein the UE communicates with the base station using a physical downlink shared channel transmission, a physical uplink shared channel transmission, a medium access control layer control element message, a physical uplink control channel transmission, or a combination thereof that is secured using the security key.

Aspect 13: The method of any of aspects 1 through 12, wherein determining the one or more eigenvalues or eigenvectors comprises: determining the one or more eigenvalues or eigenvectors using one or more resources in accordance with the configuration.

Aspect 14: The method of aspect 13, wherein the one or more resources are contiguous or non-contiguous resource elements, contiguous or non-contiguous resource blocks, contiguous or non-contiguous physical resource block groups, a wideband frequency band, or a combination thereof.

Aspect 15: The method of any of aspects 1 through 14, wherein receiving the control message comprises: receiving the control message that configures an uplink resource for transmitting the sounding reference signal and a downlink resource for receiving the downlink reference signal, wherein the uplink resource is quasi-co located with the downlink resource.

Aspect 16: The method of any of aspects 1 through 15, wherein receiving the control message comprises: receiving the control message that configures a bandwidth part for transmitting the sounding reference signal and receiving the downlink reference signal, wherein the sounding reference signal is transmitted and the downlink reference signal is received on the bandwidth part in accordance with the configuration.

Aspect 17: The method of any of aspects 1 through 16, wherein communicating with the base station comprises: encoding one or more fields in a physical uplink control channel transmission, a physical uplink shared channel transmission, or both, using the security key.

Aspect 18: The method of any of aspects 1 through 17, wherein communicating with the base station comprises: decoding one or more fields in a downlink control information message using the security key.

Aspect 19: The method of aspect 18, wherein the one or more fields comprise a redundancy value index, a modulation and coding scheme index, a time domain resource assignment index, a frequency domain resource assignment index, or a combination thereof.

Aspect 20: The method of any of aspects 1 through 19, further comprising: determining, based at least in part on a value of the security key, a subset of search spaces of a plurality of search spaces configured at the UE or one or more blind search parameters; and performing blind decoding in the subset of search spaces, using the one or more blind search parameters, or both.

Aspect 21: The method of any of aspects 1 through 20, further comprising: determining that the one or more eigenvalues or eigenvectors determined at the UE are different from base station computed one or more eigenvalues or eigenvectors; and retransmitting the one or more sounding reference signal based at least in part on the determining.

Aspect 22: The method of any of aspects 1 through 21, wherein receiving the downlink reference signal comprises: receiving a channel state information reference signal.

Aspect 23: A method for wireless communications at a base station, comprising: transmitting, to a UE, a control message indicating a configuration for a security key generation procedure for communications between the UE and the base station; receiving, from the UE, a sounding reference signal in accordance with the configuration; determining one or more one or more eigenvalues or eigenvectors based at least in part on a channel estimation of a channel associated with the sounding reference signal; transmitting, to the UE, a downlink reference signal in accordance with the configuration; and communicating, with the UE, via the communications secured using a security key derived using the one or more eigenvalues or eigenvectors.

Aspect 24: The method of aspect 23, further comprising: receiving, from the UE, an indication of UE computed one or more eigenvalues or eigenvectors; and comparing, the one or more eigenvalues or eigenvectors computed by the base station to the UE computed one or more eigenvalues or eigenvectors; and transmitting, to the UE, a downlink control information message at indicates a security key derivation status resulting from the comparing, wherein the UE communicates with the base station based at least in part on the security key derivation status.

Aspect 25: The method of aspect 24, wherein receiving the indication of the UE computed one or more eigenvalues or eigenvectors comprises: receiving a hash value of the UE computed one or more eigenvalues or eigenvectors, wherein the base station compares the hash value of the UE computed one or more eigenvalues or eigenvectors to a hash value of the one or more eigenvalues or eigenvectors computed by the base station.

Aspect 26: The method of any of aspects 24 through 25, wherein transmitting the downlink control information message comprises: transmitting the downlink control information message that is encoded with the security key to indicate the security key derivation status.

Aspect 27: The method of any of aspects 23 through 26, further comprising: receiving, from the UE, an uplink control information message that is encoded using the security key derived at the UE; and decoding the uplink control information message using the security key.

Aspect 28: The method of aspect 27, wherein the uplink control information message includes an acknowledgement corresponding to the downlink reference signal.

Aspect 29: The method of any of aspects 23 through 28, further comprising: transmitting, to the base station, an indication of the one or more eigenvalues or eigenvectors computed by the base station.

Aspect 30: The method of aspect 29, wherein transmitting the indication of the one or more eigenvalues or eigenvectors comprises: transmitting a hash value of the one or more eigenvalues or eigenvectors.

Aspect 31: The method of any of aspects 23 through 30, further comprising: deriving the security key using a quantized value of the one or more eigenvalues or eigenvectors in accordance with the configuration.

Aspect 32: The method of any of aspects 23 through 31, further comprising: deriving the security key using the one or more eigenvalues or eigenvectors using a hash function, a security key derivation function, or a combination thereof, in accordance with the configuration.

Aspect 33: The method of any of aspects 23 through 32, further comprising: transmitting, to the UE, an indication of one or more quantization levels used to determine a value using the one or more eigenvalues or eigenvectors, wherein the value is used to derive the security key.

Aspect 34: The method of any of aspects 23 through 33, further comprising: deriving the security key using a key derivation function in accordance with the configuration, wherein the base station communicates with the UE using a physical downlink shared channel transmission, a physical uplink shared channel transmission, a medium access control layer control element message, a physical uplink control channel transmission, or a combination thereof that is secured using the security key.

Aspect 35: The method of any of aspects 23 through 34, wherein determining the one or more eigenvalues or eigenvectors comprises: determining the one or more eigenvalues or eigenvectors using one or more resources in accordance with the configuration.

Aspect 36: The method of aspect 35, wherein the one or more resources are contiguous or non-contiguous resource elements, contiguous or non-contiguous resource blocks, contiguous or non-contiguous physical resource block groups, a wideband frequency band, or a combination thereof.

Aspect 37: The method of any of aspects 23 through 36, wherein transmitting the control message comprises: transmitting the control message that configures an uplink resource for receiving the sounding reference signal and a downlink resource for transmitting the downlink reference signal, wherein the uplink resource is quasi-co located with the downlink resource.

Aspect 38: The method of any of aspects 23 through 37, wherein transmitting the control message comprises: transmitting the control message that configures a bandwidth part for receiving the sounding reference signal and transmitting the downlink reference signal, wherein the sounding reference signal is received and the downlink reference signal is transmitted on the bandwidth part in accordance with the configuration.

Aspect 39: The method of any of aspects 23 through 38, wherein communicating with the UE comprises: decoding one or more fields a physical uplink control channel transmission, a physical uplink shared channel transmission, or both, using the security key.

Aspect 40: The method of any of aspects 23 through 39, wherein communicating with the base station comprises: encoding one or more fields in a downlink control information message using the security key.

Aspect 41: The method of aspect 40, wherein the one or more fields comprise a redundancy value index, a modulation and coding scheme index, a time domain resource assignment index, a frequency domain resource assignment index, or a combination thereof.

Aspect 42: The method of any of aspects 23 through 41, further comprising: determining, based at least in part on a value of the security key, a subset of search spaces of a plurality of search spaces configured at the UE or one or more blind search parameters; and transmitting a downlink control information message in the subset of search spaces, in accordance with the one or more blind search parameters, or both.

Aspect 43: The method of any of aspects 23 through 42, further comprising: determining that the one or more eigenvalues or eigenvectors determined at the base station are different from UE computed one or more eigenvalues or eigenvectors; and receiving a retransmission of the sounding reference signal based at least in part on the determining.

Aspect 44: The method of any of aspects 23 through 43, wherein transmitting the downlink reference signal comprises: transmitting a channel state information reference signal.

Aspect 45: An apparatus for wireless communications at a UE, comprising a processor; memory coupled with the processor; and instructions stored in the memory and executable by the processor to cause the apparatus to perform a method of any of aspects 1 through 22.

Aspect 46: An apparatus for wireless communications at a UE, comprising at least one means for performing a method of any of aspects 1 through 22.

Aspect 47: A non-transitory computer-readable medium storing code for wireless communications at a UE, the code comprising instructions executable by a processor to perform a method of any of aspects 1 through 22.

Aspect 48: An apparatus for wireless communications at a base station, comprising a processor; memory coupled with the processor; and instructions stored in the memory and executable by the processor to cause the apparatus to perform a method of any of aspects 23 through 44.

Aspect 49: An apparatus for wireless communications at a base station, comprising at least one means for performing a method of any of aspects 23 through 44.

Aspect 50: A non-transitory computer-readable medium storing code for wireless communications at a base station, the code comprising instructions executable by a processor to perform a method of any of aspects 23 through 44.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or MCS or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, a control message indicating a configuration for a security key generation procedure for communications between the UE and the base station;
transmitting, to the base station, a sounding reference signal using one or more first antennas of a plurality of antennas in accordance with the configuration;
receiving, from the base station, a downlink reference signal using the one or more first antennas in accordance with the configuration;
determining one or more eigenvalues or eigenvectors based at least in part on a channel estimation of a channel associated with the downlink reference signal; and
communicating, with the base station, via the communications secured using a security key derived using the one or more eigenvalues or eigenvectors.

2. The method of claim 1, further comprising:
transmitting, to the base station, an indication of the one or more eigenvalues or eigenvectors; and
receiving, from the base station, a downlink control information message that indicates a security key derivation status, wherein the UE communicates with the base station based at least in part on the security key derivation status.

3. The method of claim 2, wherein transmitting the indication of the one or more eigenvalues or eigenvectors comprises:
transmitting a hash value of the one or more eigenvalues or eigenvectors.

4. The method of claim 1, wherein communicating with the base station comprises:
transmitting, to the base station, an uplink control information message that is encoded using the security key.

5. The method of claim 4, wherein transmitting the uplink control information message comprises:
transmitting the uplink control information message that includes an acknowledgement corresponding to the downlink reference signal.

6. The method of claim 4, further comprising:
receiving, from the base station, a downlink control information message that indicates a security key derivation status, wherein the UE communicates with the base station based at least in part on the security key derivation status.

7. The method of claim 6, wherein receiving the downlink control information message comprises:
receiving the downlink control information message that is encoded using the security key derived at the base station; and
decoding the downlink control information message using the security key derived by the UE.

8. The method of claim 1, further comprising:
receiving, via the downlink reference signal, an indication of base station computed one or more eigenvalues or eigenvectors;
comparing, the one or more eigenvalues or eigenvectors computed by the UE to the base station computed one or more eigenvalues or eigenvectors; and
deriving the security key using the one or more eigenvalues or eigenvectors, or both, based at least in part on a result of the comparing.

9. The method of claim 1, further comprising:
deriving the security key using a quantized value of the one or more eigenvalues or eigenvectors in accordance with the configuration.

10. The method of claim 1, further comprising:
deriving the security key using the one or more eigenvalues or eigenvectors using a hash function, a security key derivation function, or a combination thereof, in accordance with the configuration.

11. The method of claim 1, wherein receiving the control message comprises:
receiving an indication of one or more quantization levels used to determine a value for the one or more eigenvalues or eigenvectors, wherein the value is used to derive the security key.

12. The method of claim 1, further comprising:
deriving the security key using key derivation function in accordance with the configuration, wherein the UE communicates with the base station using a physical downlink shared channel transmission, a physical uplink shared channel transmission, a medium access control layer control element message, a physical uplink control channel transmission, or a combination thereof that is secured using the security key.

13. The method of claim 1, wherein determining the one or more eigenvalues or eigenvectors comprises:
determining the one or more eigenvalues or eigenvectors using one or more resources in accordance with the configuration.

14. The method of claim 13, wherein the one or more resources are contiguous or non-contiguous resource elements, contiguous or non-contiguous resource blocks, contiguous or non-contiguous physical resource block groups, a wideband frequency band, or a combination thereof.

15. The method of claim 1, wherein receiving the control message comprises:
receiving the control message that configures an uplink resource for transmitting the sounding reference signal and a downlink resource for receiving the downlink reference signal, wherein the uplink resource is quasi-co located with the downlink resource.

16. The method of claim 1, wherein receiving the control message comprises:
receiving the control message that configures a bandwidth part for transmitting the sounding reference signal and receiving the downlink reference signal, wherein the sounding reference signal is transmitted and the downlink reference signal is received on the bandwidth part in accordance with the configuration.

17. The method of claim 1, wherein communicating with the base station comprises:
encoding one or more fields in a physical uplink control channel transmission, a physical uplink shared channel transmission, or both, using the security key.

18. The method of claim 1, wherein communicating with the base station comprises:
decoding one or more fields in a downlink control information message using the security key.

19. The method of claim 18, wherein the one or more fields comprise a redundancy value index, a modulation and coding scheme index, a time domain resource assignment index, a frequency domain resource assignment index, or a combination thereof.

20. The method of claim 1, further comprising:
determining, based at least in part on a value of the security key, a subset of search spaces of a plurality of search spaces configured at the UE or one or more blind search parameters; and
performing blind decoding in the subset of search spaces, using the one or more blind search parameters, or both.

21. The method of claim 1, further comprising:
determining that the one or more eigenvalues or eigenvectors determined at the UE are different from base station computed one or more eigenvalues or eigenvectors; and
retransmitting the one or more sounding reference signal based at least in part on the determining.

22. The method of claim 1, wherein receiving the downlink reference signal comprises:
receiving a channel state information reference signal.

23. A method for wireless communications at a base station, comprising:
transmitting, to a user equipment (UE), a control message indicating a configuration for a security key generation procedure for communications between the UE and the base station;
receiving, from the UE, a sounding reference signal in accordance with the configuration;
determining one or more one or more eigenvalues or eigenvectors based at least in part on a channel estimation of a channel associated with the sounding reference signal;
transmitting, to the UE, a downlink reference signal in accordance with the configuration; and
communicating, with the UE, via the communications secured using a security key derived using the one or more eigenvalues or eigenvectors.

24. The method of claim 23, further comprising:
receiving, from the UE, an indication of UE computed one or more eigenvalues or eigenvectors;
comparing, the one or more eigenvalues or eigenvectors computed by the base station to the UE computed one or more eigenvalues or eigenvectors; and
transmitting, to the UE, a downlink control information message at indicates a security key derivation status resulting from the comparing, wherein the UE communicates with the base station based at least in part on the security key derivation status.

25. The method of claim 24, wherein receiving the indication of the UE computed one or more eigenvalues or eigenvectors comprises:
receiving a hash value of the UE computed one or more eigenvalues or eigenvectors, wherein the base station compares the hash value of the UE computed one or more eigenvalues or eigenvectors to a hash value of the one or more eigenvalues or eigenvectors computed by the base station.

26. The method of claim 24, wherein transmitting the downlink control information message comprises:
transmitting the downlink control information message that is encoded with the security key to indicate the security key derivation status.

27. The method of claim 23, further comprising:
receiving, from the UE, an uplink control information message that is encoded using the security key derived at the UE; and
decoding the uplink control information message using the security key.

28. The method of claim 23, further comprising:
transmitting, to the UE, an indication of the one or more eigenvalues or eigenvectors computed by the base station.

29. A user equipment (UE) for wireless communications, comprising:
a processor;
memory coupled with the processor; and
instructions stored in the memory and executable by the processor to cause the UE to:
receive, from a base station, a control message indicating a configuration for a security key generation procedure for communications between the UE and the base station;
transmit, to the base station, a sounding reference signal using one or more first antennas of a plurality of antennas in accordance with the configuration;
receive, from the base station, a downlink reference signal using the one or more first antennas in accordance with the configuration;
determine one or more eigenvalues or eigenvectors based at least in part on a channel estimation of a channel associated with the downlink reference signal; and
communicate, with the base station, via the communications secured using a security key derived using the one or more eigenvalues or eigenvectors.

30. A base station for wireless communications, comprising:
a processor;
memory coupled with the processor; and
instructions stored in the memory and executable by the processor to cause the base station to:
transmit, to a user equipment (UE), a control message indicating a configuration for a security key generation procedure for communications between the UE and the base station;
receive, from the UE, a sounding reference signal in accordance with the configuration;
determine one or more one or more eigenvalues or eigenvectors based at least in part on a channel estimation of a channel associated with the sounding reference signal;
transmit, to the UE, a downlink reference signal in accordance with the configuration; and
communicate, with the UE, via the communications secured using a security key derived using the one or more eigenvalues or eigenvectors.
